(19) United States
(12) Patent Application Publication
(10) Pub. No.: US 2026/0101110 A1
(43) Pub. Date: Apr. 9, 2026

(54) Piezoelectric motor, and camera module using same

(71) Applicant: NINGBO SUNNY OPOTECH CO., LTD, Ningbo, Zhejiang (CN)

(72) Inventors: Kai Chen, Zhejiang (CN); Wengui DENG, Ningbo, Zhejiang (CN)

(21) Appl. No.: 18/880,272

(22) PCT Filed: Apr. 3, 2023
(86) PCT No.: PCT/CN2023/085954

§ 371 Date: Dec. 8, 2025

(30) Foreign Application Priority Data
Jul. 1, 2022 (CN) 202210774290.X
Jul. 1, 2022 (CN) 202210774300.X
Jul. 1, 2022 (CN) 202210774958.0
Jul. 1, 2022 (CN) 202210774978.8

(51) Int. Cl. H04N 23/68; G03B 5/00; H04N 23/52; H04N 23/55

(52) U.S. Cl. CPC H04N 23/687; G03B 5/00; H04N 23/52; H04N 23/55; G03B 2205/0038; G03B 2205/0061

(57) ABSTRACT

The present invention discloses a piezoelectric motor, which comprises a base, a movable assembly, which is movably connected above the base, and a piezoelectric actuator, which abuts against the movable assembly. The movable assembly is supported on the fixing assembly by a plurality of balls arranged on one side of the movable assembly, and the plurality of balls form at least one supporting plane. The drive end of the piezoelectric actuator acts on the supporting plane formed by the balls, thereby reducing the tilting moment of the piezoelectric actuator to the movable assembly.

### BACKGROUND OF THE PRESENT INVENTION

### Field of Invention

The present invention relates to a piezoelectric motor and a camera module using same, and particularly relates to a piezoelectric motor capable of achieving multi-degree-of-freedom movement.

### Background

With the increasing demand for anti-shake shooting, users are paying more attention to the anti-shake performance of camera stabilization in image shooting. Users expect camera modules with high resolution, small size, and anti-shake capability. However, in general, the pixels of the camera module increase along with the enlargement of the image plane, and the total track length (TTL) of the optical elements also increases with the enlargement of the image plane at the same time. The size of optical elements or photosensitive devices will also increase, and the stroke and driving force requirements of the matched motor will also increase accordingly. The increase of the motor's size causes the camera module's size to also increase.

In the prior art, voice coil motors with elastic sheets are commonly used. However, due to the issue of the load-bearing capacity of elastic sheets, the elastic sheets cannot effectively accommodate the large stroke and heavy weight requirements of optical elements or photosensitive devices. In the prior art, there are also uses of ball-bearing motors to achieve motor anti-shake functionality, but the response frequency of ball-bearing motors is low, making them difficult to respond to high-precision and high-frequency anti-shake requirements, and it is easy to cause abnormal noise. The above issues can be significantly improved with piezoelectric motors. However, since piezoelectric motors operate as a contact-type actuator solution, it requires piezoelectric motors to frictionally actuate with the driven components. In the design process of piezoelectric motors, special attention needs to be paid to the yield rate during assembly, reliability during use, product performance, and miniaturization. As a result, the solution of piezoelectric motors requires certain design to achieve better performance.

### SUMMARY OF THE PRESENT INVENTION

To address the above issues, the present invention provides a piezoelectric motor and a camera module using same, which can achieve at least one or more of the following beneficial effects:
1. Achieves high-precision anti-shake effects;
2. Structural improvements and optimizations enhance the assembly yield of the piezoelectric motor;
3. Improves product reliability;
4. Reduces product size.

Through the understanding of the following description and drawings, the further objectives and advantages of the present invention will be fully demonstrated.

The present invention provides a piezoelectric motor, which comprises:
a fixing assembly;
a movable assembly connected movably to the fixing assembly;
a piezoelectric actuator abutting against the movable assembly, wherein the movable assembly is supported on the fixing assembly by a plurality of balls arranged on one side of the movable assembly, wherein the plurality of balls form at least one support plane and a driving end of the piezoelectric actuator acts on the support plane.

In some embodiments, the present invention provides a piezoelectric motor, in such the balls comprise side wall balls and end face balls, the driving direction of the drive end of the piezoelectric actuator is perpendicular to the supporting plane formed by the side wall balls, and the driving direction of the drive end of the piezoelectric actuator is parallel to the supporting plane formed by the end face balls.

In some embodiments, the present invention provides a piezoelectric motor, in such the side wall balls comprise at least one first-height ball and at least one second-height ball. In a side projection, the position where the drive end of the piezoelectric actuator abuts against the movable assembly is located in a middle area defined by the connection lines between the at least one first-height ball and the at least one second-height ball.

In some embodiments, the present invention provides a piezoelectric motor, in such the at least one first-height ball is one in number, and the at least one second-height ball are two in number, and in a projection along a certain direction, the position of the drive end of the piezoelectric actuator within the entire stroke trajectory is located within the triangular area formed by the connection lines between the at least one first-height ball and the second-height balls.

In some embodiments, the present invention provides a piezoelectric motor, in such there exists an inclination of the force provided by the drive end of the piezoelectric actuator to the movable assembly during the entire stroke trajectory relative to the plane formed by the connection lines of the balls.

In some embodiments, the present invention provides a piezoelectric motor, in such the at least one first-height ball is at the same distance from the second-height balls, and in a projection along a certain direction, the connection lines between the at least one first-height ball and the second-height balls form an equilateral triangular area.

In some embodiments, the present invention provides a piezoelectric motor, in such the balls comprise at least two piezoelectric actuator same-side balls arranged above the piezoelectric actuator, and the two piezoelectric actuator same-side balls are arranged on an outer side of the piezoelectric actuator.

In some embodiments, the present invention provides a piezoelectric motor, in such in a projection along a certain direction, the two piezoelectric actuator same-side balls are located at the same height as the two second-height balls.

In some embodiments, the present invention provides a piezoelectric motor, in such in a projection along a certain direction, the two piezoelectric actuator same-side balls are located between the two second-height balls.

In some embodiments, the present invention provides a piezoelectric motor, in such the distance between each of the piezoelectric actuator same-side ball and its adjacent second-height ball is the same, and in a projection along a certain direction, the two piezoelectric actuator same-side balls and the two second-height balls form an isosceles trapezoid, and the piezoelectric actuator is located near the shorter parallel side of the isosceles trapezoid.

In some embodiments, the present invention provides a piezoelectric motor, in such the piezoelectric actuator comprises a first piezoelectric actuator and a second piezoelectric actuator, the movable assembly comprises a first frame and a second frame, and the second frame is movably connected to the first frame, the first piezoelectric actuator is fixedly installed on one side of the base, and the second piezoelectric actuator is fixedly installed on one side of the first frame, the driving directions of the first piezoelectric actuator and the second piezoelectric actuator are orthogonal.

Correspondingly, compared with the prior art, the piezoelectric motor of the present invention simplifies the design of the driving structure of the camera module by designing the relative positional relationship between the area formed by the ball connection lines and the piezoelectric actuator, reduces the tilting moment of the piezoelectric actuator by optimizing the structure of the balls, and reduces the tilting moment of the piezoelectric actuator by optimizing the structure of the piezoelectric actuator.

According to another aspect of the present invention, the present invention further provides a piezoelectric motor, which comprises:
a fixing assembly;
a movable assembly connected movably to the fixing assembly;
a piezoelectric actuator abutting against the movable assembly, wherein the piezoelectric actuator comprises a piezoelectric vibrator and a piezoelectric friction head disposed on a side of the piezoelectric vibrator close to the movable assembly;
an elastic support portion for generating a potential energy perpendicular to a driving direction of the piezoelectric actuator and a potential energy along a height direction of the movable assembly; and
a circuit board connected to a side of the piezoelectric vibrator opposite to the piezoelectric friction head and the elastic support portion is partially arranged on a side of the circuit board away from the piezoelectric vibrator.

In some embodiments, the present invention provides a piezoelectric motor, in such a friction plate is fixedly connected to one side of the movable assembly, the friction plate is fixed on the movable assembly, the friction plate is arranged parallel to one side of the piezoelectric vibrator, and the piezoelectric friction head is located at the center of the friction plate.

In some embodiments, the present invention provides a piezoelectric motor, in such the circuit board and the elastic sheet have pass-through holes at the same positions, and the movable assembly has a pass-through hole of a size to accommodate the piezoelectric vibrator.

In some embodiments, the present invention provides a piezoelectric motor, in such the elastic sheet has an elastic sheet first through-hole, and the size of the elastic sheet first through-hole is smaller than the size of one side of the piezoelectric vibrator.

In some embodiments, the present invention provides a piezoelectric motor, in such the size of the elastic sheet first through-hole is smaller than the size of the pass-through hole of the circuit board.

In some embodiments, the present invention provides a piezoelectric motor, in such the elastic sheet further comprises an elastic sheet second through-hole and an elastic sheet third through-hole, and the size of the elastic sheet first through-hole is larger than the sizes of the elastic sheet second through-hole and the elastic sheet third through-hole.

In some embodiments, the present invention provides a piezoelectric motor, in such the areas of the elastic sheet second through-hole and the elastic sheet third through-hole are the same, and the area of the elastic sheet first through-hole is more than twice the area of the elastic sheet second through-hole.

In some embodiments, the present invention provides a piezoelectric motor, in such the elastic sheet further comprises a set of elastic sheet connecting arms, and the elastic sheet connecting arms provide pressure forces on at least two sides of the piezoelectric vibrator.

In some embodiments, the present invention provides a piezoelectric motor, in such the elastic sheet further has at least one elastic sheet positioning hole, and the elastic sheet is pressed onto the movable assembly through the elastic sheet positioning hole.

In some embodiments, the present invention provides a piezoelectric motor, in such the circuit board further has at least one mounting portion, and the circuit board is located on the movable assembly through the mounting portion, with the circuit board located on the inner side of the elastic sheet.

Correspondingly, compared with the prior art, the piezoelectric motor of the present invention provides a pre-pressure force to the piezoelectric vibrator by arranging an elastic sheet on the piezoelectric vibrator; ensures the pressure forces always provided on at least two sides of the piezoelectric vibrator by optimizing the structure of the elastic sheet; makes the circuit board undergo a certain degree of deformation and the elastic sheet provide a certain inward potential energy when the piezoelectric vibrator is energized to move, by optimizing the structure of the elastic sheet, thereby making the elastic sheet, the circuit board, and the piezoelectric vibrator in the first direction pressed more tightly, thus reducing the degree of deformation of the circuit board.

According to another aspect of the present invention, the present invention further provides a piezoelectric motor, which comprises:
a base;
a movable assembly movably connected above the base;
a piezoelectric actuator assembly abutting against the movable assembly;
a housing connected fixedly to the base and having an accommodating space, wherein the movable assembly is located within the housing;
a plurality of balls arranged between the housing and the movable assembly and between the base and the movable assembly, respectively; and
an elastic support portion for generating a potential energy applied to the plurality of ball, so as to urge the plurality of balls toward the base and clamp the plurality of balls between the housing and the movable assembly.

In some embodiments, the present invention provides a piezoelectric motor, in such the piezoelectric motor further comprises a circuit board, the piezoelectric actuator assembly is fixedly connected to the circuit board, and the elastic support portion is arranged on the side of the circuit board away from the piezoelectric actuator, the elastic support portion provides potential energy perpendicular to the movement direction of the piezoelectric actuator, the potential energy provided by the elastic support portion to the circuit board is perpendicular to the potential energy provided by the elastic support portion to the balls located between the housing and the movable assembly.

In some embodiments, the present invention provides a piezoelectric motor, in such the movable assembly comprises a first frame and a second frame, the first frame and the second frame are movably connected with each other, the first frame and the base are movably connected with each other, and the second frame is movably connected within the housing through the balls, in such the degree of freedom of movement of the second frame relative to the housing is in the same direction as the degree of freedom of movement of the second frame relative to the base.

In some embodiments, the present invention provides a piezoelectric motor, in such the second frame comprises second frame outer ball grooves, second frame inner ball grooves, and second frame upper ball grooves, in such the second frame outer ball grooves are provided on the outer surface of the second frame, the second frame inner ball grooves are provided on the inner surface of the second frame, and the second frame upper ball grooves are provided on the upper surface of the second frame.

In some embodiments, the present invention provides a piezoelectric motor, in such the second frame comprises the second frame upper ball grooves, the second frame upper ball grooves are formed on the upper surface of the second frame, the second frame upper ball grooves comprise four ball grooves formed on the upper surface of the second frame, and the second frame is movably connected within the housing through the balls placed in the second frame upper ball grooves.

In some embodiments, the present invention provides a piezoelectric motor, in such the positions of the four second frame upper ball grooves in a projection along a certain direction are located in the middle of the four sides of the second frame.

In some embodiments, the present invention provides a piezoelectric motor, in such the piezoelectric actuator comprises a first piezoelectric actuator and a second piezoelectric actuator, the first piezoelectric actuator and the second piezoelectric actuator are arranged orthogonal to each other, and during at least one part of an entire stroke, the force directions of the driving end of the first piezoelectric actuator and the driving end of the second piezoelectric actuator are each perpendicular to the plane defined by the balls in the four upper ball grooves of the second frame.

In some embodiments, the present invention provides a piezoelectric motor, in such from the view of a projection along a certain direction, the four second frame upper ball grooves comprise at least two ball grooves located between the first piezoelectric actuator and the second piezoelectric actuator.

In some embodiments, the present invention provides a piezoelectric motor, in such each of the second frame upper ball grooves is provided with one ball.

In some embodiments, the present invention provides a piezoelectric motor, in such the first frame comprises a first frame ball groove, the second frame comprises a second frame ball groove, and the first frame is movably connected to the base through the ball located in the first frame ball groove, and the second frame is movably connected to the first frame through the ball located in the second frame ball groove.

In some embodiments, the present invention provides a piezoelectric motor, in such the base has a base ball groove, in such the base ball groove and the first frame ball groove cooperate with each other to form an accommodating space for the ball.

In some embodiments, the present invention provides a piezoelectric motor, the elastic support portion comprises a transverse elastic sheet, and the transverse elastic sheet abuts against the ball located in the second frame ball groove.

Correspondingly, compared with the prior art, the piezoelectric motor of the present invention provides support forces in both horizontal and vertical directions for the movable assembly by setting a support element on the movable assembly, thereby enhancing the reliability of the movable assembly; by arranging ball supports at different positions of the movable assembly, the height of the movable assembly can be constrained by the balls, after the height of the movable assembly is constrained by the balls, the impact resistance of the movable assembly is increased, improving the reliability of the movable assembly; by optimizing the structures of the movable assembly, the base, and the housing, the strength of the housing when assembled onto the second frame is increased, while the degrees of freedom provided by the housing do not hinder the movement of the second frame relative to the base.

According to another aspect of the present invention, the present invention further provides a piezoelectric motor, which comprises:
a fixing assembly;
a circuit board, the circuit board is fixed on different sides of the movable assembly;
a movable assembly, the movable assembly is movably connected to the fixing assembly;
a piezoelectric actuator assembly, the piezoelectric actuator assembly abuts against the movable assembly;
in such the movable assembly further comprises a first frame and a second frame, in such the second frame is movably connected within the first frame;
in such the circuit board is installed on one side of the piezoelectric actuator assembly, the circuit board further comprises a first main body and a second main body, the plane where the second main body is located is orthogonal to the plane where the first main body is located, a first turning body is provided between the second main body and the first main body, the first turning body are flexible.

In some embodiments, the present invention provides a piezoelectric motor, in such the circuit board further comprises a second turning body, the second turning body is connected to the upper surface of the second frame of the movable assembly, the second main body is fixed to the side surface of the second frame, the second turning body is folded in at least two different plane directions relative to the second main body.

In some embodiments, the present invention provides a piezoelectric motor, in such the circuit board further comprises a third main body, the first main body is formed with a first pass-through hole, the second main body is formed with a second pass-through hole, and the third main body is formed with a third pass-through hole, the first main body further comprises a first mounting portion, the second main body further comprises a second mounting portion, and the third main body further comprises a third mounting portion, the piezoelectric actuator assembly comprises a first piezoelectric vibrator, a second piezoelectric vibrator, and a third piezoelectric vibrator, the first piezoelectric vibrator is mounted on the first mounting portion, the second piezoelectric vibrator is mounted on the second mounting portion, and the third piezoelectric vibrator is mounted on the third mounting portion, the size of the first pass-through hole is smaller than the size of the first piezoelectric vibrator, the size of the second pass-through hole is smaller than the size of the second piezoelectric vibrator, and the size of the third pass-through hole is smaller than the size of the third piezoelectric vibrator, the first pass-through hole is formed in the center area of the first main body, the second pass-through hole is formed in the center area of the second main body, and the third pass-through hole is formed in the center area of the third main body.

In some embodiments, the present invention provides a piezoelectric motor, in such the first main body is provided with a first positioning portion, the second main body is provided with a second positioning portion, and the third main body is provided with a third positioning portion, the first positioning portion is arranged on the outer side of the first mounting portion, the second positioning portion is arranged on the outer side of the second mounting portion, and the third positioning portion is arranged on the outer side of the third mounting portion, the first main body is positioned and assembled onto the fixing assembly through the first positioning portion, the second main body is positioned and assembled onto the first frame through the second positioning portion, and the third main body is positioned and assembled onto the second frame through the third positioning portion.

In some embodiments, the present invention provides a piezoelectric motor, in such the first main body is arranged with a first connecting arm, the second main body is arranged with a second connecting arm, and the third main body is arranged with a third connecting arm, the center line of the first connecting arm aligns with the center line of the first pass-through hole, the center line of the second connecting arm aligns with the center line of the second pass-through hole, and the center line of the third connecting arm aligns with the center line of the third pass-through hole, the first mounting portion is connected to the first positioning portion via the first connecting arm, the second mounting portion is connected to the second positioning portion via the second connecting arm, and the third mounting portion is connected to the third positioning portion via the third connecting arm, the first connecting arm, the second connecting arm and the third connecting arm are flexible.

In some embodiments, the present invention provides a piezoelectric motor, in such the first pass-through hole, the second pass-through hole, and the third pass-through hole are each a rectangular notch, the piezoelectric actuator assembly comprises a first piezoelectric vibrator, a second piezoelectric vibrator and a third piezoelectric vibrator, the first piezoelectric vibrator, the second piezoelectric vibrator, and the third piezoelectric vibrator are rectangular in shape, the size of the first pass-through hole is smaller than the size of the first piezoelectric vibrator, the size of the second pass-through hole is smaller than the size of the second piezoelectric vibrator, and the size of the third pass-through hole is smaller than the size of the third piezoelectric vibrator.

In some embodiments, the present invention provides a piezoelectric motor, in such the second turning body further comprises a first turning portion, a second turning portion, and a third turning portion, in such the first turning portion, the second turning portion, and the third turning portion are orthogonal, and the second turning portion is installed on the upper surface of the second frame, in such any two of the first turning portion, the second turning portion, and the third turning portion are perpendicular to each other.

In some embodiments, the present invention provides a piezoelectric motor, in such the movable assembly further comprises a third frame, the third frame is movably connected within the second frame via the balls, the second main body and the third main body are electrically connected through an adapter portion, and the adapter portion is fixed on the upper surface of the second frame.

In some embodiments, the present invention provides a piezoelectric motor, in such the second turning body further comprises a first turning portion, a second turning portion, and a third turning portion, in such any two of the first turning portion, the second turning portion, and the third turning portion are perpendicular to each other, and the second turning portion is installed on the upper surface of the second frame.

In some embodiments, the present invention provides a piezoelectric motor, in such the second turning body further comprises a turning body mounting portion, in such the turning body mounting portion is installed on the upper surface of the second frame, the plane where the turning body mounting portion is located is perpendicular to the plane where the third main body is located.

In some embodiments, the present invention provides a piezoelectric motor, in such the first main body comprises a first extension portion, and the second main body comprises a second extension portion, in such the first extension portion and the second extension portion extend along the height direction, with the first extension portion perpendicular to the first connecting arm, and the second extension portion perpendicular to the second connecting arm.

Correspondingly, compared with the prior art, the piezoelectric motor of the present invention provides an installation foundation for various components and enables electrical connections by setting a circuit board on the movable assembly; by providing mounting structures on the circuit board, it provides positioning and installation structures, thereby improving assembly accuracy; by optimizing the structure of the circuit board, it provides anti-torsion functionality, reducing the reaction force of the circuit board.

In the following description, other embodiments and features are partially elaborated, and will be apparent to those skilled in the art upon reviewing the specification or may be learned by practice of the disclosed subject matter. Further understanding of the features and advantages of the present disclosure can be achieved by referring to the remainder of the specification and drawings that form part of this application.

### BRIEF DESCRIPTION OF THE DRAWINGS

FIG. 1 is a sectional schematic view of a camera module of the piezoelectric motor according to an embodiment of the present invention.

FIG. 2 is an exploded schematic view of the piezoelectric motor according to an embodiment of the present invention.

FIG. 3 is a disassembly schematic view of the piezoelectric motor according to an embodiment of the present invention.

FIG. 4A is a schematic view of the moment of the piezoelectric actuator in the piezoelectric motor according to an embodiment of the present invention.

FIG. 4B is a schematic view of the moment of the piezoelectric actuator in the piezoelectric motor according to an embodiment of the present invention.

FIG. 5 is a structural schematic view of the piezoelectric actuator in the piezoelectric motor according to an embodiment of the present invention.

FIG. 6 is a structural schematic view of the piezoelectric actuator in the piezoelectric motor according to an embodiment of the present invention.

FIG. 7 is a structural schematic view of the piezoelectric actuator in the piezoelectric motor according to an embodiment of the present invention.

FIG. 8 is a sectional structural schematic view of the piezoelectric motor according to an embodiment of the present invention.

FIG. 9 is an exploded structural schematic view of the piezoelectric motor according to an embodiment of the present invention.

FIG. 10 is a schematic view of the frame of the piezoelectric motor according to an embodiment of the present invention.

FIG. 11 is a structural schematic view of the circuit board of the piezoelectric motor according to an embodiment of the present invention.

FIG. 12 is a perspective schematic view of the movable assembly of the piezoelectric motor according to an embodiment of the present invention.

FIG. 13A shows an optional embodiment of the movable assembly of the piezoelectric motor according to an embodiment of the present invention.

FIG. 13B shows another optional embodiment of the movable assembly of the piezoelectric motor according to an embodiment of the present invention.

Through a more detailed description of the embodiments of the present invention in conjunction with the drawings, the above and other objectives, features, and advantages of the present invention will become more apparent. The drawings are provided to further illustrate the embodiments of the present invention and form part of the specification, and they are used to explain the present invention together with the embodiments but do not constitute a limitation on the present invention. In the drawings, the same reference numbers generally represent the same components or steps.

### DETAILED DESCRIPTION OF THE PREFERRED EMBODIMENT

The following provides a detailed description of exemplary embodiments of the present invention with reference to the drawings. Apparently, the described embodiments are merely part of the embodiments of the present invention, and not all of the embodiments of the present invention, it should be understood that the present invention is not limited to the exemplary embodiments described herein.

In the description of the present invention, it should be noted that, for the orientation terms, if there are terms such as “center,” “transverse,” “longitudinal,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise” and other indications of orientation and position relationship are based on the orientation or position relationship shown in the drawings. These terms are provided solely for the convenience of describing the present invention and simplifying the explanation and should not be construed as requiring that the referenced devices or components must have a specific orientation, be constructed in a particular manner, or operate in a particular orientation. Thus, they should not be understood as limiting the scope of protection of the present invention.

It should also be noted that the terms “first,” “second,” etc., as used in the specification and claims of this application, are only intended to distinguish between similar objects and do not necessarily indicate a particular sequential order.

The terms “comprising” and “having” and any variations thereof in the specification and claims of this application are intended to cover a non-exclusive inclusion, for example, a process, method, system, product, or device that includes a series of steps or units is not necessarily limited to those steps or units explicitly listed, but may include other steps or units not explicitly listed or inherent to these processes, methods, products, or devices.

In the description of the present invention, it should also be noted that, unless otherwise explicitly specified and limited, the terms “arrange,” “install,” “connect,” and “link” should be understood in a broad sense, for example, it can be a fixed connection, or a detachable connection, or an integral connection; it can be a mechanical connection, or an electrical connection; it can be a direct connection, or a contact connection, or an indirect connection through an intermediate medium, and can be the communication between two elements. For those of ordinary skill in the art, the specific meaning of the above terms in the present invention can be understood according to specific situations.

### Application Overview

As described in the background art, a piezoelectric motor, as a contact-type actuator solution, requires maintaining tight contact between the drive end of the piezoelectric motor and the carrier, but no interference should occur during assembly and operation. Therefore, it is necessary to optimize the design of the piezoelectric motor and its components. The piezoelectric motor components need to satisfy characteristics such as easy assembly, prevention of component interference, improved driving performance, and enhanced product reliability.

Moreover, the miniaturization of motors has always been one of the core demands of manufacturers. A key product improvement is how to reduce the size of the piezoelectric motor without compromising performance.

On the other hand, achieving size reduction and improved assembly yield rate among piezoelectric motor components while ensuring functionality and reliability is an even more challenging matter.

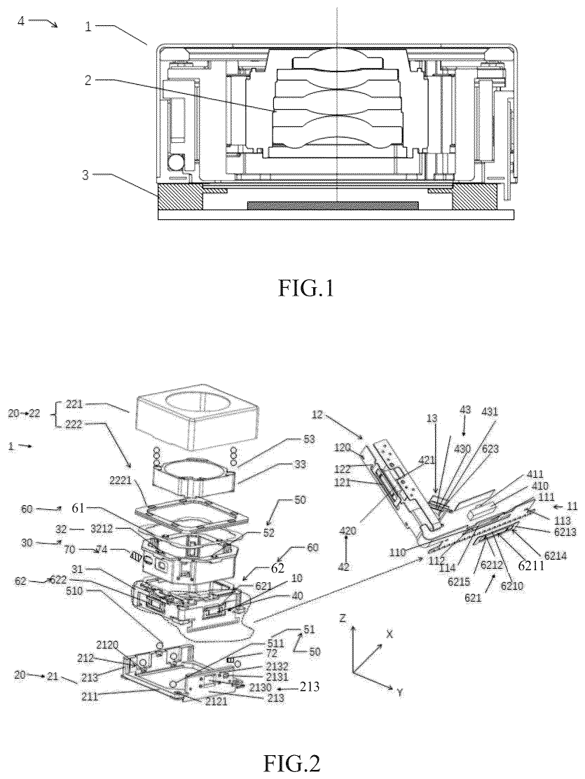

Referring to FIG. 1, an exemplary camera module comprising a piezoelectric motor will be described, which comprises a piezoelectric motor 1, a lens assembly 2, and a photosensitive assembly 3. The lens assembly 2 has an optical axis, while the piezoelectric motor 1 is arranged on the outer side of the lens assembly 2. The photosensitive assembly 3 is positioned below the lens assembly 2, and the lens assembly 2 is maintained on the photosensitive path of the photosensitive assembly 3. The lens assembly 2 is used to collect imaging light from a subject being photographed and propagate the imaging light to the photosensitive assembly 3. The photosensitive assembly 3 is used to receive the light passing through the lens assembly 2 to generate image information.

As an example, the piezoelectric motor 1 can drive the lens assembly 2 to move along the optical axis direction to adjust the distance between the lens assembly 2 and the photosensitive assembly 3, thereby achieving a focusing function. The piezoelectric motor 1 can drive the lens assembly 2 to move in a plane direction perpendicular to the optical axis, causing the lens assembly 2 to translate relative to the photosensitive assembly 3, thereby achieving an anti-shake function. Many improvements according to the embodiments of the present invention relate to the improvements of the piezoelectric motor 1 combination technology. In the following descriptions of many specific structural improvements regarding the piezoelectric motor, the specific component names and positional relationships do not constitute a limitation to the technical solutions described in the present invention, provided that the inventive concept and the achieved technical effects remain unchanged.

Referring to FIGS. 2-8, an exemplary piezoelectric motor 1 will be described. The present application proposes a piezoelectric motor 1, which comprises a circuit board 10, a fixing assembly 20, a movable assembly 30, a piezoelectric actuator assembly 40, balls 50, an elastic support portion 60, and a position sensing assembly 70. In such, the movable assembly 30 is accommodated within the fixing assembly 20, and the drive end of the piezoelectric actuator assembly 40 abuts against one end of the movable assembly 30. The movable assembly 30 is movably supported within the fixing assembly 20 by the balls 50, so that the movable assembly 30 can move with minimal frictional resistance when subjected to the driving force from the piezoelectric actuator assembly 40.

A portion of the circuit board 10 is fixedly connected to the fixing assembly 20, and another portion of the circuit board 10 is fixedly connected to the movable assembly 30. The portion of the circuit board 10 fixed to the fixing assembly 20 and the portion of the circuit board 10 fixed to the movable assembly 30 are configured to bend between them and have a certain degree of flexibility, so that when the movable assembly 30 moves, the circuit board 10 has minimal obstruction to the movement of the movable assembly 30. At least one piezoelectric actuator assembly 40 is arranged on one side surface of the circuit board 10 and is electrically connected to it. In some optional embodiments, at least a portion of the piezoelectric actuator assembly 40 is arranged on the side of the circuit board 10 facing the movable assembly 30. Furthermore, at least one position sensing assembly 70 is electrically connected and installed on the same side surface of the circuit board 10 where the piezoelectric actuator assembly 40 is installed. The position sensing assembly 70 is used to detect the relative position between the movable assembly 30 and the fixing assembly 20, thereby enabling faster driving speed of the piezoelectric motor 1.

At least one elastic support portion 60 is arranged on the circuit board 10. In some optional embodiments, the elastic support portion 60 is arranged on the surface of the circuit board 10 opposite to the side where the piezoelectric actuator assembly 40 is installed, that is, the elastic support portion 60 is arranged on a side surface of the circuit board 10 relatively farther away from the optical axis. The elastic support portion 60 provides potential energy perpendicular to the driving direction of the piezoelectric actuator assembly 40, that is, provides a pre-pressure force for the drive end of the piezoelectric actuator assembly 40 to abut against the movable assembly 30, thereby improving the driving performance and response frequency of the piezoelectric motor 1.

The fixing assembly 20 comprises a base 21 and a housing 22, with the housing 22 located above the base 21. In such, the base 21 and the housing 22 are snapped with each other to achieve a fixed connection. An accommodating cavity is defined within the housing 22 to accommodate the movable assembly 30, the circuit board 10, the piezoelectric actuator assembly 40, the balls 50, the elastic support portion 60, the position sensing assembly 70, and other components. The housing 22 can prevent internal components from being damaged by external impacts.

Referring to FIG. 2, the circuit board 10 fixed to the base 21 is electrically connected to the photosensitive assembly 3 via pins 15, thereby enabling signal control of the piezoelectric motor 1 by the circuit board in the photosensitive assembly 3.

The lower end of the movable assembly 30 is movably connected to the upper surface of the base 21 via at least one ball 50 provided therebetween, and the movable assembly 30 is movably connected to the housing 22 via a portion of the balls 50 provided on the upper end of the movable assembly 30. In some optional embodiments, to maintain the stability of the movable interface, at least three balls are provided between the lower end of the movable assembly 30 and the upper surface of the base 21. In some optional embodiments, the balls are provided at both the upper and lower ends of the movable assembly 30, respectively movably connected to the base 21 and the housing 22. The balls support the gap height between the movable assembly 30 and the base 21 as well as the housing 22, thereby preventing the movable assembly 30 from shaking or tilting relative to the base 21 and the housing 22 in the direction of the optical axis, increasing impact resistance and improving product reliability.

In some optional embodiments, the elastic support portion 60 comprises a transverse elastic sheet 61 and a longitudinal elastic sheet 62, both the transverse elastic sheet 61 and the longitudinal elastic sheet 62 are thin sheet structures. The transverse elastic sheet 61 extends in a plane direction perpendicular to the optical axis and is arranged on the inner surface of the top side of the housing 22, providing downward potential energy along the optical axis direction. The longitudinal elastic sheet 62 extends in a direction parallel to the installation surface of the piezoelectric motor 1 and provides potential energy in a direction perpendicular to the optical axis. Multiple longitudinal elastic sheets 62 are respectively attached to multiple piezoelectric actuators 40 provided at different orientations to provide potential energy in different directions, thereby improving the integration of the piezoelectric motor 1 and the flatness of the components within the piezoelectric motor 1.

The upper surface of the transverse elastic sheet 61 is fixedly connected to the inner wall surface of the housing 22, and the lower surface of the transverse elastic sheet 61 is pre-pressed against the balls 50 between the movable assembly 30 and the housing 22, so that the movable assembly 30 is supported by the elastic force of the transverse elastic sheet 61. The transverse elastic sheet 61 provides potential energy in the direction of the optical axis, so that the movable assembly 30 is subjected to a downward pre-pressure force along the optical axis direction. In some optional embodiments, the lower surface of the transverse elastic sheet 61 is pre-pressed against at least three balls 50, thereby ensuring that the movable assembly 30 can be assembled flatly, which helps improve the structural stability of the piezoelectric motor 1.

Specifically, the movable assembly 30 comprises a first frame 31, a second frame 32, and a third frame 33. The first frame 31 is located above the base 21, and the first frame 31 is movably connected to the base 21 via at least one ball 50 provided therebetween. In some optional embodiments, at least three balls 50 are arranged between the first frame 31 and the base 21, and the first frame 31 has freedom of movement relative to the base 21 in a first direction. The second frame 32 is located inside the first frame 31, and the second frame 32 is movably connected to the first frame 31 via at least one ball 50 provided therebetween, enabling the second frame 32 to have freedom of movement relative to the first frame 31 in a second direction.

Specifically, the piezoelectric actuator assembly 40 comprises a first piezoelectric actuator 41, a second piezoelectric actuator 42, and a third piezoelectric actuator 43, in such one end of the first piezoelectric actuator 41 is fixedly connected to the circuit board 10, and the other end of the first piezoelectric actuator 41 abuts against the first frame 31, so that the first frame 31 moves in the first direction when driven by the first piezoelectric actuator 41.

One end of the second piezoelectric actuator 42 is fixed to the circuit board 10, and the other end of the second piezoelectric actuator 42 abuts against the second frame 32, causing the second frame 32 to move in the second direction when driven by the second piezoelectric actuator 42.

Specifically, a second direction of movement freedom of the second frame 32 relative to the first frame 31 is orthogonal to a first direction of movement freedom of the first frame 31 relative to the base 21, so that in the embodiment of the present invention, the second frame 32 has the ability to move in a plane direction perpendicular to the optical axis relative to the base 21. During anti-shake operation, the second frame 32 can be driven to move in the plane direction relative to the base 21, that is, the piezoelectric motor 1 can achieve optical anti-shake function.

The third frame 33 is arranged within the second frame 32, and the third frame 33 is movably connected to the second frame 32 via a portion of the balls 50, enabling the third frame 33 to have freedom of movement relative to the second frame 32 in a third direction. The third direction is parallel to the direction of the optical axis.

The driving direction of the second piezoelectric actuator 42 is orthogonal to the driving direction of the first piezoelectric actuator 41, and the driving direction of the third piezoelectric actuator 43 is orthogonal to both the driving direction of the first piezoelectric actuator 41 and the driving direction of the second piezoelectric actuator 42, so that the third frame 33 can achieve anti-shake in a plane perpendicular to the optical axis and also perform focus processing along the optical axis direction. Therefore, in this embodiment, the camera module 4 with the piezoelectric motor 1 can not only meet the horizontal movement required for anti-shake imaging of the camera module but also perform focus processing of images.

According to the embodiment of the present invention, the piezoelectric driving method requires a frictional connection relationship between the drive end and the driven component to reduce resistance during movement, which can reduce the frictional resistance loss of the piezoelectric motor 1. The balls, as motor holding components, can improve the parallelism of movement. The point contact method employed by the balls can also reduce frictional force, and compared to the planar contact friction method, it can reduce the friction loss of the actuator, thereby increasing the service life of the piezoelectric actuator 40 and the piezoelectric motor 1.

For ease of understanding, referring to FIG. 2, the first direction can be represented as the x-axis direction in a three-dimensional coordinate system, the second direction is represented as the y-axis direction perpendicular to the x-axis direction and forms a horizontal plane with the x-axis direction, and the third direction can be represented as the z-axis direction perpendicular to both the x-axis and y-axis, with the z-axis parallel to the optical axis direction.

Referring to FIG. 2, to facilitate the demonstration of the structure of the piezoelectric actuator assembly 40, FIG. 2 uses a dashed box and arrow line to illustrate an enlarged view of the piezoelectric actuator assembly 40, and also enlarges the display of the first piezoelectric actuator 41, the second piezoelectric actuator 42, and the third piezoelectric actuator 43 comprised in the piezoelectric actuator assembly 40.

According to the embodiment of the present invention, the first, second, and third piezoelectric actuators 41, 42, and 43 further comprise first, second, and third piezoelectric vibrators 410, 420, and 430, respectively. The piezoelectric vibrator is a substrate with an inverse piezoelectric effect that contracts or expands according to the polarization direction and the electric field direction. It can be used by polarizing the substrate in the thickness direction of single crystal, polycrystalline ceramic, polymer, etc. The inverse piezoelectric effect refers that when an electric field is applied in the polarization direction of the dielectric, the dielectric undergoes mechanical deformation when a potential difference is generated. The piezoelectric vibrator has the function of ultrasonic vibration and can achieve reciprocating swing or elliptical motion on a specifically arranged electrode layer to drive the drive end of the piezoelectric actuator. In the embodiment of the present application, the piezoelectric vibrator is composed of piezoelectric material and connected to the circuit board to achieve circuit conduction, thereby providing power excitation to the piezoelectric actuator.

On one surface of the first, second, and third piezoelectric vibrators 410, 420, and 430, first, second, and third friction heads 411, 421, and 431 are fixedly connected, respectively, in such the friction head, affected by the deformation of the piezoelectric vibrator, achieves a unit motion trajectory in an elliptical or reciprocating swing manner.

Specifically, the degree of freedom of movement of the second frame 32 relative to the housing 22 is in the same direction as the degree of freedom of movement of the second frame 32 relative to the base 21, and the balls 50 provided between the second frame 32 and the housing 22 can support the second frame 32 without hindering the movement of the second frame 32.

The housing 22 further comprises a pressure plate 222 and a housing body 221. The upper surface of the transverse elastic sheet 61 is installed on the lower surface of the pressure plate 222, and the housing body 221 is fixedly connected to the upper side of the pressure plate 222. In such both the upper and lower surfaces of the pressure plate 222 are provided with pressure plate positioning structures 2221, such as positioning holes, grooves, or other structures, for better positioning connection with the housing body 221.

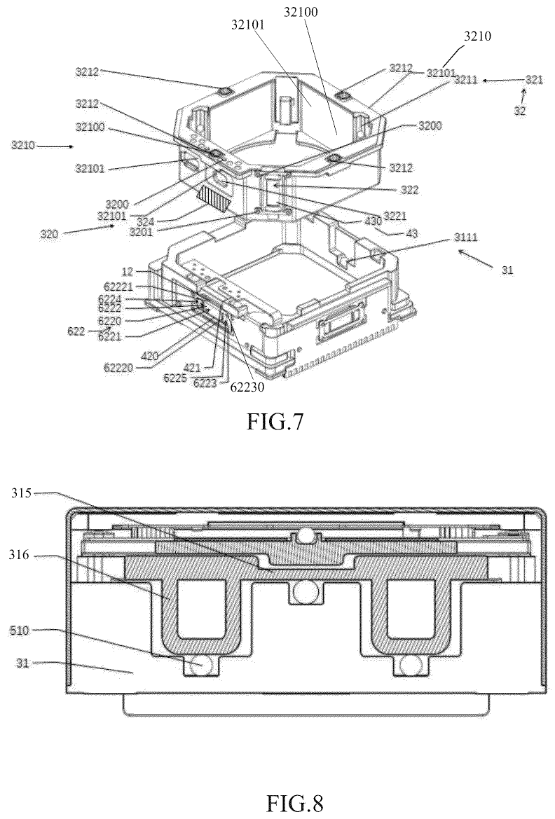

The upper surface of the second frame 32 is provided with at least three second frame upper ball grooves 3212. In some optional embodiments of the present application, the number of the second frame upper ball grooves 3212 is four. The second frame 32 is movably connected inside the housing 22 via balls 50 limited in the second frame upper ball grooves 3212. When the number of balls is greater than three, a rolling plane is formed by the method of forming a surface with three points, ensuring the flatness of the moving part during rolling. Referring to FIG. 7, the four second frame upper ball grooves 3212 are located in the middle of the four sides of the upper surface of the second frame 32 in a projection view. By providing the ball grooves in the middle of the four sides of the second frame 32 to give way to the focusing mechanism and circuit components located at the four corners, the size of the second frame 32 can be reduced, and the size of the piezoelectric motor 1 can be further reduced. One ball is placed in each of the second frame upper ball grooves 3212, achieving a four-point support movable connection within the housing 22. According to the embodiment of the present invention, the second frame upper ball grooves 3212 and the balls 50 placed in the second frame upper ball grooves 3212 are connected in a ball-groove manner, that is, both the width and length of the second frame upper ball grooves 3212 are larger than the volume of the balls 50, allowing the balls in the second frame upper ball grooves 3212 to move in multiple directions. At the same time, the ball-groove structure enables the second frame 32 to have at least first and second degrees of freedom of movement between it and the housing 22, so that the degrees of freedom of movement of the second frame 32 relative to the housing 22 are the same as the degrees of freedom of movement of the second frame 32 relative to the base 21.

The transverse elastic sheet 62 is connected to the lower side of the pressure plate 222, and the lower surface of the transverse elastic sheet 61 abuts against the balls provided in the second frame upper ball grooves 3212, so that the transverse elastic sheet 61, as a force-applying component, always provides a pre-pressure force to the balls provided in the second frame upper ball grooves 3212, ensuring that the second frame 32, the first frame 31, and the base 21 are subjected to the pre-pressure force of the transverse elastic sheet 61 for flatness correction after assembly. For ease of explanation, the pre-pressure force provided by the transverse elastic sheet 61 to the second frame 32 is represented by a dashed line (labeled F2).

More specifically, the transverse elastic sheet 61 can provide downward potential energy to the second frame 32. Since the transverse elastic sheet 61 acts on the first frame 31 and the second frame 32, the transverse elastic sheet 61 actually provides potential energy perpendicular to the movement direction of the first frame 31 and the second frame 32, so that the second frame 32 and the first frame 31 are tightly assembled to prevent the first frame 31 and the second frame 32 from tilting relative to the base 21.

On the other hand, when the pressure plate 222 is assembled from top to bottom, it provides a downward pre-pressure force along the optical axis to the transverse elastic sheet 61, and the pressure plate 222 will correct the transverse elastic sheet 61 to a horizontal position. The balls in the second frame upper ball grooves 3212 abut against the lower surface of the transverse elastic sheet 61, and the transverse elastic sheet 61 has a certain strength, thereby limiting the upper end of the second frame 32 and increasing the installation strength of the housing 22 assembled to the second frame 32. At the same time, the degree of freedom between the housing 22 and the second frame 32 does not hinder the movement of the second frame 32 relative to the base 21, thereby increasing the reliability of the piezoelectric motor 1.

For ease of understanding, according to the embodiment of the present invention, the housing 22 provides a limiting function to the second frame 32 through the balls 50, that is, prevents the second frame 32 from freely detaching upward from the first frame 31. On the other hand, during assembly, when the housing 22 is assembled from top to bottom, it applies downward squeezing force to the second frame 32 via the balls 50, thereby correcting the assembly levelness of the second frame 32 relative to the first frame 31. Additionally, the squeezing force can also be transmitted to the first frame 31, correcting the assembly levelness of the first frame 31 relative to the base 21. Overall, the housing 22 provides an upper end limiting function for the movable assembly 30, and further, it can be understood that the housing 22 provides an upper end limiting function for the first frame 31 and the second frame 32, or that the housing 22 provides an upper end holding function for the first frame 31 and the second frame 32.

Still referring to FIG. 2, since the base 21 is movably arranged at the lower end of the first frame 31, both the first frame 31 and the second frame 32 are supported by the base 21. At the same time, the first frame 31 and the second frame 32 are movably supported via multiple balls 50 provided between the base 21 and the first frame 31 and the second frame 32, so that the first frame 31 and the second frame 32 do not tilt in the direction of the optical axis, and the driving of the first frame 31 and the second frame 32 in a plane perpendicular to the optical axis is not restricted.

The base 21 further comprises a base body 211 and base side plates 213 extending upward from at least two sides of the base body 211, in such the base body 211 is located at the bottom side of the base 21 and serves as a base support. At the same time, the base body 211 is positioned and fixed with the housing body 221. The base body 211 can provide an installation reference for components arranged on the base 21. The upper surface of the base body 211 is formed with at least one base ball groove 212. The base side plates 213 extend from both sides of the base body 211 along the optical axis direction. From a side view, the base side plate 213 on one side is roughly a flat plate shape. The base side plate 213 on one side is relatively narrower than the base side plate 213 on the other side. At least two base ball grooves 212 are disposed at the base body 211 located on the side where the base side plate 213 is located. And at least three base side wall ball grooves 2120 are defined in a side wall of the base side plate 213 located on the other side. By arranging the balls 50 in the base ball grooves 212, the base side plates 213 and the movable assembly 30 are movably connected.

The base side plate 213 is fixedly connected to the circuit board 10. The circuit board 10 comprises a first main body 11, a second main body 12, and a third main body 13, in such the first piezoelectric actuator 41 is electrically connected to the first main body 11, the second piezoelectric actuator 42 is electrically connected to the second main body 12, and the third piezoelectric actuator 43 is electrically connected to the third main body 13.

The base side plate 213 further comprises a side plate mounting portion 2132. The side plate mounting portion 2132 is provided on at least one side of the base side plate 213. According to embodiments of the present invention, in one optional embodiment, the side plate mounting portion 2132 is provided on the relatively narrower base side plate 213. In such the side plate mounting portion 2132 comprises a set of positioning posts for positioning and assembling the first main body 11 of the circuit board 10 and the longitudinal elastic sheet 62. The side plate mounting portion 2132 further comprises an area on its side surface for attaching the first main body 11 of the circuit board 10.

Referring to FIG. 2, the base side plate 213 is formed with a base first through-hole 2130 and a base second through-hole 2131, in such the base first through-hole 2130 is formed in the middle part of the base side plate 213, the base first through-hole 2130 is substantially in the shape of a rectangular through-hole. The size of the base first through-hole 2130 is larger than that of the first piezoelectric actuator 41, thereby enabling the piezoelectric actuator 41 to be accommodated within the base first through-hole 2130. The base second through-hole 2131 is used to accommodate a first position sensor 72.

In such, the base first through-hole 2130 and the base second through-hole 2131 are located on the same side of the base side plate 213, and the side plate mounting portion 2132 is located around the base first through-hole 2130. In one embodiment of the present application, the side plate mounting portion 2132 is a set of mounting posts, providing a positioning and mounting area for assembling the circuit board 10 on the base 21. Referring to FIG. 2, in one embodiment of the present application, the side plate mounting portion 2132 is arranged on the outer side of the base side plate 213. The side plate mounting portion 2132, the base first through-hole 2130, and the base second through-hole 2121 are located on the same base side plate 213. At the same time, through the base first through-hole 2130, the base second through-hole 2131, and the side plate mounting portion 2132 located on the outer side of the base side plate 213, the first piezoelectric actuator 41 and the first position sensor 72 can be installed on the same side of the circuit board 10, which can reduce the size required in design for the base 21 due to positioning, installation, and avoidance of the piezoelectric motor 1, thereby reducing the overall size of the piezoelectric motor 1. In some optional embodiments, the first position sensor 72 can detect the position of the first frame 31 relative to the base 21 by detecting the magnitude of magnetic flux. In this solution, the way that the position sensor is provided on the same side and near the piezoelectric actuator 40 is adopted, which can improve the detection accuracy of the position sensor, thereby increasing the response frequency of the piezoelectric motor 1.

The position sensing assembly 70 comprises a first magnet 71 and a first position sensor 72, in such the first position sensor 72 is fixedly installed on the first main body 11, in such the base second through-hole 2131 has a larger size than the first position sensor 72. In such the first magnet 71 is fixedly installed on the side surface of the first frame 31. The first position sensor 72 can detect changes in magnetic flux, thereby detecting the relative position of the first magnet 71 relative to the first position sensor 72. When the first frame 31 moves in a predetermined direction relative to the base 21, the first frame 31 drives the first magnet 71 to move, and the magnetic field generated by the first magnet 71 changes. When the magnetic flux received by the first position sensor 72 changes, the position difference of the first magnet 71 relative to the first position sensor 72 can be obtained by calibrating the magnetic flux of the first position sensor 72.

The position sensing assembly further comprises a second magnet 73 and a second position sensor 74, in such the second position sensor 74 is fixedly installed on the second main body. Similar to the first magnet 71, the second magnet 73 is fixedly installed on the second frame 32. A first frame first through-hole 312 and a first frame second through-hole 313 are formed on one side surface of the first frame 31, in such the second piezoelectric vibrator 420 is accommodated in the first frame first through-hole 312, and the second position sensor 74 is accommodated in the first frame second through-hole 313. The specific structural relationship can be referred to the content of the first magnet 71 and the first position sensor 72 mentioned above.

The position sensing assembly further comprises a third magnet and a third position sensor, in such the third position sensor 76 is fixedly installed on the third main body 13.

It can be understood that by arranging a position sensor near the piezoelectric actuator, the position sensor can detect the relative position change of the piezoelectric actuator more accurately. By accommodating the position sensor in a through-hole and placing a magnet opposite to the position sensor, the position sensor can be closer to the magnet, detecting a stronger magnetic field and making the position sensor more sensitive. This enables the piezoelectric motor 1 to have a faster response frequency or improved control accuracy.

Referring to FIGS. 2, 5, and 6, the first frame 31 comprises a first frame mounting portion 310 and first frame ball grooves 311 formed on the first frame 31. In such the first frame mounting portion 310 is arranged on the outer surface of the first frame 31. The first frame ball grooves 311 cooperate with the base ball grooves 212 to form a guiding space for the balls in a single direction, thereby enabling the first frame 31 to have a degree of freedom of movement in the first direction between it and the base 21.

Referring to FIG. 6, the first frame 31 further comprises a first frame first through-hole 312 formed on one side wall of the first frame 31 and a first friction plate 314 provided on an adjacent side wall of the first frame 31, in such the first frame first through-hole 312 is a rectangular through-hole, and the size of the first frame first through-hole 312 is larger than the size of the second piezoelectric vibrator 420, so that the second piezoelectric actuator 42 is accommodated in the first frame first through-hole 312 in the manner of facing the first frame first through-hole 312. In such on the side close to the second piezoelectric actuator 42, a first frame second through-hole 313 is formed on the first frame, in such the first frame second through-hole 313 near the first frame first through-hole 312.

A first friction plate 314 is fixedly provided on the side wall of the first frame 31, and the first friction plate 314 is arranged opposite to the first piezoelectric actuator 41, in such the first friction plate 314 is accommodated in a groove on the side surface of the first frame 31 to reduce the size of the piezoelectric motor 1. The first friction plate 314 abuts against the first friction head 411 of the first piezoelectric actuator 41.

A second friction plate 324 is fixedly provided on one side wall of the second frame 32, and the second friction plate 324 is arranged opposite to the second piezoelectric actuator 42, in such the second friction plate 324 is accommodated in a groove on the side surface of the second frame 32 to reduce the size of the piezoelectric motor 1.

In such a third friction plate 333 is fixedly provided at one corner of the third frame 33, and the third friction plate 333 is arranged opposite to the third piezoelectric actuator 43, in such the third friction plate 333 is accommodated on the corner side wall of the third frame 33 to better integrate the external actuator structure and circuit components, achieving a more integrated product design.

The friction plates can be made of aluminum oxide material to reduce friction loss, thereby increasing the working lifespan of the piezoelectric motor 1. On the other hand, the friction plates can provide good flatness, making it easier for the piezoelectric actuator to drive.

Referring to FIG. 2, the first piezoelectric vibrator 410 is rectangular and strip-shaped. The first piezoelectric vibrator 410 is fixedly connected to the first main body 11, and one side of the first main body 11 is fixedly installed on the side plate mounting portion 2132. The inner surface of the first piezoelectric vibrator 410 is fixedly connected to a first piezoelectric friction head 411. The first piezoelectric friction head 411 protrudes and is fixedly arranged at the center of the inner surface of the first piezoelectric vibrator 410, which can increase the unit driving stroke of the first piezoelectric friction head 411.

In the initial state (i.e., when the motor is reset), the first piezoelectric friction head 411 abuts against the center of the first friction plate 314. When the first piezoelectric vibrator 410 is excited by a power signal, the first piezoelectric vibrator 410 vibrates or deforms, and the first piezoelectric vibrator 410 drives the first piezoelectric friction head 411 to vibrate or deflect. The first piezoelectric vibrator 410 and the first friction plate 314 are tightly fitted, enabling the first piezoelectric friction head 411 to generate friction force relative to the first friction plate 314, thereby driving the first frame 31. In this embodiment, the friction head can be considered as the drive end of the piezoelectric actuator. Similarly, in the initial state, the second piezoelectric friction head 421 and the second friction plate 324, as well as the third piezoelectric friction head 431 and the third friction plate 333, are connected in the same manner.

The longitudinal elastic sheet 62 further comprises a first elastic sheet 621, a second elastic sheet 622, and a third elastic sheet 623, in such the first elastic sheet 621 is pre-pressed on the outer side of the first main body 11, the second elastic sheet 622 is pre-pressed on the outer side of the second main body 12, and the third elastic sheet 623 is pre-pressed on the outer side of the third main body 13. The first elastic sheet 621, the second elastic sheet 622, and the third elastic sheet 623 respectively provide potential energy perpendicular to the driving directions of the first piezoelectric actuator 41, the second piezoelectric actuator 42, and the third piezoelectric actuator 43, thereby providing the pre-pressure force for the drive ends of the piezoelectric actuator assembly 40 to abut against the movable assembly 30. This improves the motion performance and response frequency of the piezoelectric motor 1.

The first piezoelectric vibrator 410 is accommodated in the base first through-hole 2130, reducing the size increase caused by the external placement of the piezoelectric vibrator 410 and reducing the size of the piezoelectric motor 1. By accommodating the first piezoelectric vibrator 410, the outer surface of the first piezoelectric vibrator 410 is fixed to the first main body 11, and the inner surface of the first piezoelectric vibrator 410 serves as the deformation driving surface of the first friction head 411. The potential energy of the first elastic sheet 621 can increase the gap margin of the piezoelectric motor 1, meaning that the piezoelectric actuator is relatively more tightly abutted against the movable frame, thereby increasing the deformation range of the deformation driving surface design.

Referring to FIG. 2, the first main body 11 of the circuit board 10 is plate-shaped. The first main body 11 further comprises a first mounting portion 110, a first connecting arm 112, and a first positioning portion 113. The first mounting portion 110 is ring-shaped, with a rectangular opening forming a first pass-through hole 111 in the middle. The first piezoelectric vibrator 410 can be attached to the solid ring portion of the first mounting portion 110. The rectangular opening of the first mounting portion 110 is arranged as a clearance on the back of the first piezoelectric vibrator 410, which can increase the reliability of the piezoelectric motor 1 and reduce the risk of detachment caused by vibration or resonance. The deformation on the back of the first piezoelectric vibrator 410 is avoided by the first pass-through hole 111 of the first mounting portion 110, increasing installation reliability.

The first positioning portion 113 is fixedly connected to the side plate mounting portion 2132 of the base. The first positioning portion 113 serves to position and attach the first main body 11. The first positioning portion 113 is configured as a plate-shaped structure with positioning holes, and the first positioning portion 113 is provided on the outer side of the first mounting portion 110. Two first connecting arms 112 are flexible, and the first mounting portion 110 is connected to the first positioning portion 113 of the first main body 11 by the way that the two first connecting arms 112 on both sides extend. The first main body 11 is connected to the positioning posts on the outer surface of the base side plate 213 through the positioning holes provided on the first positioning portion 113, thereby improving the assembly accuracy of the camera module. The first connecting arms 112 allow the first main body 11 to have a certain installation margin adjustment when assembling the first piezoelectric actuator 41, reducing the reliability risks caused by tight assembly and vibration of the piezoelectric actuator.

Additionally, the first mounting portion 110 has a first extension portion 114 along the optical axis direction. Therefore, the first mounting portion 110 has degrees of freedom relative to the first main body 11 not only in the extending directions of the two connecting arms but also along the optical axis direction. Therefore, the first mounting portion 110 has at least a degree of freedom perpendicular to the optical axis direction relative to the first positioning portion 113, thereby meeting the movable margin required for the rotation and deflection generated by the friction head during the operation of the piezoelectric vibrator.

Similarly, the second mounting portion 120 can also be provided with a second extension portion 124 along the optical axis direction. The optical axis direction can also be considered as the height direction. Therefore, according to the embodiment of the present invention, the first and second main bodies further comprise first and second extension portions, respectively. The first and second extension portions extend along the height direction, and the first and second extension portions are perpendicular to the first and second connecting arms, respectively, thereby enabling the circuit board to provide movable space in two directions for each piezoelectric actuator.

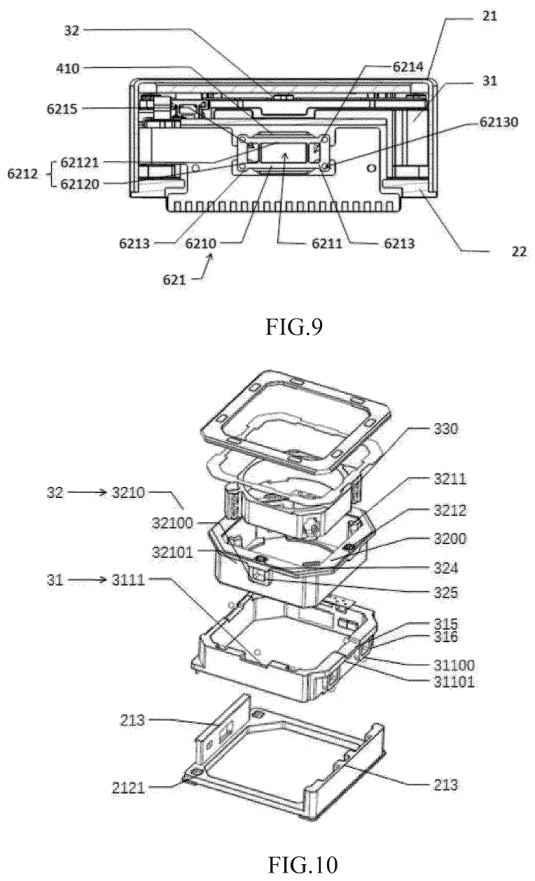

Referring to FIGS. 7 and 9, the first elastic sheet 621 comprises a first elastic sheet pre-pressure portion 6210, in such the first elastic sheet pre-pressure portion 6210 is arranged in the center of the first elastic sheet 621, the first elastic sheet pre-pressure portion 6210 is arranged on the back of the first piezoelectric vibrator 410. The first elastic sheet pre-pressure portion 6210 provides a pre-pressure force on the back of the first piezoelectric vibrator 410. A first elastic sheet first through-hole 6211 is formed in the middle of the first elastic sheet pre-pressure portion 6210. Four first elastic sheet connecting arms 6212 are arranged around the first elastic sheet pre-pressure portion 6210. The four first elastic sheet connecting arms 6212 provide support for the first piezoelectric vibrator 410 in the plane direction. The first elastic sheet first through-hole 6211 corresponds to the back of the first piezoelectric vibrator 410, and the first elastic sheet first through-hole 6211 serves to avoid the deformation of the back of the first piezoelectric vibrator 410, preventing the first piezoelectric vibrator 410 from interfering with the first elastic sheet 621 during operation, thereby increasing the reliability of the piezoelectric motor 1.

Additionally, the first elastic sheet connecting arms 6212 comprise a pair of first elastic sheet longitudinal connecting arms 62120 extending along the optical axis direction and a pair of first elastic sheet transverse connecting arms 62121 extending perpendicular to the optical axis direction, in such the first elastic sheet longitudinal connecting arms 62120 and the first elastic sheet transverse connecting arms 62121 are integrally extended with each other to form a rectangular frame body to pre-press and support the first main body of the circuit board 10, thereby providing a rectangular frame pre-pressure force on the back of the first piezoelectric vibrator 410 to support the first piezoelectric vibrator 410, ensuring that the first piezoelectric friction head 411 on the first piezoelectric vibrator 410 always abuts against the first friction plate 314.

The first elastic sheet pre-pressure portion 6210 is provided with first elastic sheet side portions 6213 integrally extending from both sides, in such the two first elastic sheet side portions 6213 are respectively formed with a first elastic sheet second through-hole 6214 and a first elastic sheet third through-hole 6215, in such the first elastic sheet second through-hole 6214 and the first elastic sheet third through-hole 6215 have the same size. The first elastic sheet side portions 6213 are provided with mounting holes, thereby enabling the first elastic sheet 621 to be fixed to the base side plate 213 through the mounting holes on the first elastic sheet side portions 6213. On the other hand, by providing the first elastic sheet second through-hole 6214 and the first elastic sheet third through-hole 6215 on both sides of the first elastic sheet pre-pressure portion 6210, the movable margin of the first elastic sheet pre-pressure portion 6210 can be increased.

The first elastic sheet 621 is elastic, and the first elastic sheet longitudinal connecting arms 62120 separate the first elastic sheet second through hole 6214, the first elastic sheet third through hole 6215 and the first elastic sheet first through hole 6211 from one another. The through-holes reduce the deformation amount of the elastic sheet, correspondingly increasing the elastic potential energy of the first elastic sheet longitudinal connecting arms 62120.

It can be understood that the piezoelectric vibrator will deform when excited by an electrical signal. In some embodiments, the piezoelectric vibrator is formed by stacking multiple electrode layers. When signals are input to the multiple electrode layers respectively, the whole piezoelectric vibrator vibrates to drive the friction head to move. Generally, the deformation in the middle area of the piezoelectric vibrator is the largest, so the stroke of the friction head will also be large. Sometimes, in order to increase the unit stroke of the piezoelectric vibrator, the deformation in the middle area of the inner and outer surfaces of the piezoelectric vibrator will be designed to have larger vibration amplitude, requiring a greater pre-pressure force to reduce assembly interference. According to the embodiment of the present invention, the first elastic sheet first through-hole 6211, the first elastic sheet second through-hole 6214, and the first elastic sheet third through-hole 6215 of the first elastic sheet 621 can avoid collision interference between the circuit board 10 and the piezoelectric vibrator, thereby improving the operational reliability of the piezoelectric motor 1. The greater the elastic deformation stroke provided by the elastic sheet, the greater the working efficiency of the piezoelectric motor 1 can be relatively improved.

It can be understood that the pre-pressure force provided by the first elastic sheet 621 is perpendicular to the driving direction of the first piezoelectric actuator 41, thereby enabling the piezoelectric actuator 41 to move freely while always being subjected to the pre-pressure force of the first elastic sheet 621, maintaining the abutting state required for the first piezoelectric actuator 41 to drive.

Specifically, the area of the first elastic sheet first through-hole 6211 is greater than or equal to twice the area of the first elastic sheet second through-hole 6214 and the first elastic sheet third through-hole 6215, thereby increasing the elastic recovery force of the first elastic sheet 621 and always maintaining the abutting state required for the first piezoelectric actuator 41 to drive.

The four corners of the first elastic sheet side portions 6213 are each formed with a first elastic sheet positioning hole 62130. The first elastic sheet positioning hole 62130 is a through-hole structure, allowing the first elastic sheet 621 to be easily installed on the side plate mounting portion 2132 of the base. The first elastic sheet 621 is directly fixed to the base side plate 213. Additionally, the first elastic sheet positioning holes 62130 used for fixing of the first elastic sheet 621 and the positioning holes on the first positioning portion 113 of the circuit board 10 are separate from each other. Therefore, the fixing relationship between the first elastic sheet 621 and the base side plate 213 is not affected by the assembly of the circuit board 10. Furthermore, the dimensional variations caused by the vibration of the first piezoelectric actuator 41 during operation will not affect the assembly stability of the first elastic sheet 621, ensuring a relatively stable connection between the first elastic sheet 621 and the base side plate 213.

In summary, the first elastic sheet 621 according to the embodiment of the present invention can serve to fix and limit the first piezoelectric vibrator 410 while also providing a certain pre-pressure force.

In order to facilitate the explanation of the embodiment of the present application, the balls 50 can further comprise at least one first ball 51, at least one second ball 52, and at least one third ball 53. In such the first ball 51 is arranged in the ball groove between the first frame 31 and the base 21, the first ball 51 primarily serves to movably connect the first frame 31 and the base 21, allowing the first frame 31 to move relative to the base 21 along the first direction. In such the second ball 52 is arranged in the ball groove between the first frame 31 and the second frame 32, the second ball 52 is also arranged between the second frame 32 and the housing 22, the second ball 52 primarily serves to movably connect the first frame 31 and the second frame 32, and the second ball 52 also serves to movably connect the second frame 32 and the housing 22. In such the third ball 53 is arranged in the ball groove between the second frame 32 and the third frame 33, the third ball 53 primarily serves to movably connect the second frame 32 and the third frame 33, allowing the third frame 33 to move relative to the second frame 32 along the third direction.

Referring to FIG. 2, the base ball grooves 212 further comprise base side wall ball grooves 2120 and at least one set of base end face ball grooves 2121, in such the base side wall ball grooves 2120 are formed on the inner wall of the base side plate 213, with a quantity of three, in such at least two of the three base side wall ball grooves 2120 are arranged at height positions of the base side plate 213 along the optical axis direction, so that when the first frame 31 is supported by the balls 50 provided in the three base side wall ball grooves 2120, the two connected parties use balls of different heights as support points, so that the moment generated by the supporting force is more dispersed and planar, reducing the likelihood of rotation caused by single-ball or single-row ball support. This ensures the flatness between the frames during the operation of the piezoelectric motor 1.

On the other hand, the base end face ball grooves 2121 are arranged on the upper surface of the base body 211 and are positioned at the two corner locations of the base body 211. The first balls 51 further comprise first side wall balls 510 and first end face balls 511, in such the first side wall balls 510 are provided in the base side wall ball grooves 2120, the first end face balls 511 are provided in the base end face ball grooves 2121. There are three first side wall balls 510, with one first side wall ball 510 provided in each base side wall ball groove 2120, and one first end face ball 511 provided in each base end face ball groove 2121. That is to say, one ball is provided in each ball groove between the first frame 31 and the base 21, thereby reducing the friction force between the first frame 31 and the base 21.

As shown in FIGS. 7, 8, and 9, the top side of the first end face ball 511 is in contact with and movably rubs against the bottom side of the first frame 31, while the first side wall ball 510 and the outer side wall of the first frame 31 are movably rubbing against each other. In a specific embodiment of the present application, the side wall of the first frame 31 extends outward to form a first frame top extension portion 315 and at least two first frame side wall extension portions 316. The first side wall ball 510 at the relatively higher position and the lower surface of the top extension portion 315 of the first frame 31 are movably rubbing against each other. The first side wall balls 510 at the relatively lower position and the lower surfaces of the two first frame side wall extension portions 316 at the bottom of the first frame 31 are movably rubbing against each other. At the same time, the width of the avoidance groove preset above the base side wall ball groove 2120 at the relatively lower height is slightly larger than the width of the side wall extension portion 316, which is used to limit the movable stroke of the first frame 31.

In one embodiment of the present application, the first side wall ball 510 and the first end face ball 511 have the same volume, thereby facilitating the assembly of universal ball models. The depth of the base end face ball groove 2121 is less than the depth of the base side wall ball groove 2120, which can reduce the wall thickness in certain areas and reduce the thickness of the base, thereby reducing the size of the piezoelectric motor 1. The two first side wall balls 510 at the same height are at the same height as the two first end face balls 511, ensuring that the bottom surface of the first frame 31 and the base 21 are planarly supported by four balls of the same height between them, thereby ensuring the flatness between the first frame 31 and the base 21. At the same time, the depth of the side wall ball grooves 2120 at the same height is greater than that of the base end face ball groove 2121, ensuring that the first side wall balls 510 placed in the side wall ball grooves 2120 at the same height rub against both the outer side wall of the first frame 31 and the bottom side of the first frame side wall extension portion 316, while also reducing the overall size.

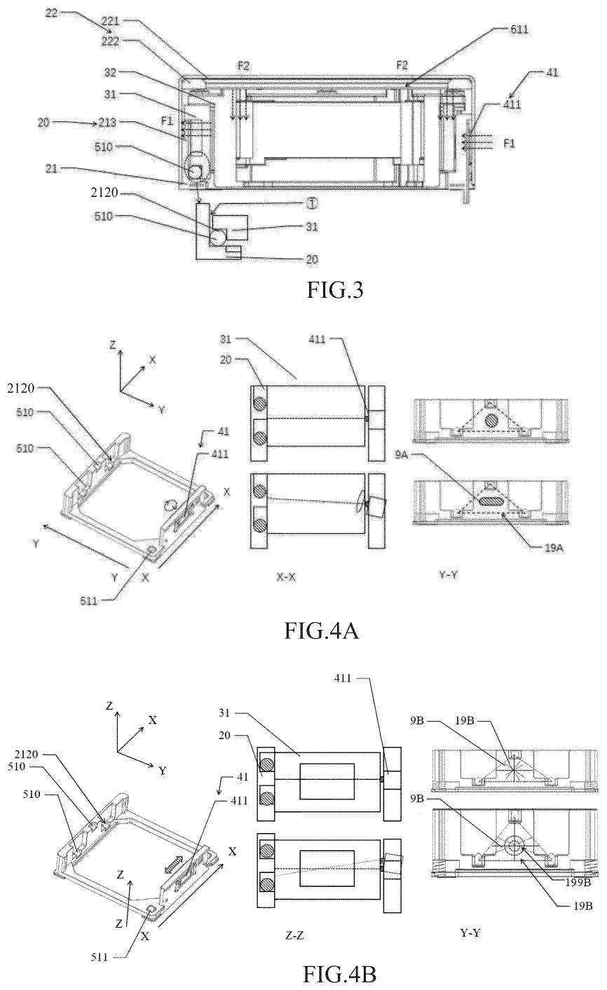

As shown in FIG. 3, in one embodiment of the present application, the width of the base side wall ball groove 2120 extending inward is less than the diameter of the first side wall ball 510, and the width of the base end face ball groove 2121 is greater than the diameter of the first end face ball 511. This ensures that when the first frame 31 is assembled onto the base 21, the balls act as point supports, allowing the first frame 31 to be adjusted by the first side wall ball 510 when assembled to the base 21, so that both the top and side of the first side wall ball 510 can abut against the first frame 31 without interference. The width and length of the base end face ball groove 2121 are greater than the diameter of the first end face ball 511, allowing the first end face ball 511 to have free movement space within the base end face ball groove 2121. The assembly of the first frame 31 onto the base 21 is capable of being adjusted using the movable space margin of the first end face ball 511 in the base end face ball groove 2121, so that both the top and side of the first end face ball 511 can abut against the first frame 31 without interference. In one embodiment of the present application, the width of the base side wall ball groove 2120 is illustrated as 0.9 mm, the width and length of the base end face ball groove 2121 are 1.5 mm, and the diameter of the first side wall ball 510 is 1 mm, thereby enabling the first end face ball 511 to have a 0.5 mm adjustment space within the base end face ball groove 2121.

The first side wall ball 510 is arranged on the opposite side as the first piezoelectric actuator 41. Preferably, the number of the first side wall balls 510 is three (for ease of display, only one is shown in cross-section in the figure), and the connection lines of the first side wall balls 510 form a triangle, in such at least one of the first side wall balls 510 is located at the upper part of the base side plate 213 and on the axis of the connection line between the centers of the other two first side wall balls 510.

Referring to FIG. 3, in such the first elastic sheet 621 provides a lateral pre-pressure force for the first piezoelectric actuator 41, and the first piezoelectric friction head 411 of the first piezoelectric actuator 41 provides a lateral pre-pressure force for the first frame 31. In FIG. 3, the pre-pressure force is represented by a dotted line with an arrow (labeled F1), in such the first frame 31 is connected to the base 21 through three first side wall balls 510. On the opposite side of the first piezoelectric actuator 41, there is a gap between the first frame 31 and the base side plate 213 that is not greater than the diameter of the side wall ball 510, which is marked with \textcircled{1} as indication in FIG. 3, thereby enabling the first frame 31 and the base side plate 213 to be always supported by the balls between them without interference or surface friction that could cause excessive friction between the first frame 31 and the base side plate 213. This ensures smooth movement of the first piezoelectric actuator 41 during operation, reduces friction, and ensures that the working load required by the first piezoelectric actuator 41 is not too high, extending the service life of the piezoelectric actuator.

Referring to FIGS. 2 and 3, in a preferred embodiment of the present application, similarly, the downward potential energy provided by the upper elastic sheet 611 is transmitted to the first frame 31 through the balls placed between the second frame 32 and the first frame 31. Therefore, it also ensures that the first frame 31 is tightly assembled relative to the base 21. Overall, the specific position of the movable assembly 30 in the piezoelectric motor 1 is determined by the pre-pressure of the elastic potential energy comprising the downward potential energy provided by the upper elastic sheet 611 and the horizontal potential energy provided by the longitudinal elastic sheet 62 on the outer side of the piezoelectric actuator 40, thereby increasing the assembly yield of the piezoelectric motor 1 and improving the reliability of the piezoelectric motor 1.

On the other hand, specifically, when the first frame 31 and the second frame 32 of the movable assembly 30 are pre-pressed by the upper elastic sheet 611, the housing 22 acts as an upper holding component and can serve to flatten the piezoelectric motor 1 when the housing 22 is assembled from top to bottom. The first frame 31 is subjected to the left and right potential energy of the elastic sheet of the piezoelectric actuator 41, causing that the positions of the first frame 31 and the second frame 32 are subjected to the potential energy of the elastic sheet. This makes it easier to assemble the movable assembly 30 flatly, resulting in a higher assembly yield and more stable assembled products.

A detailed advantage will be illustrated as an example. The balls, as supporting components, serve to connect the upper elastic sheet 611 and the first frame 31 and/or the second frame 32. When the housing 22 is assembled onto the base 21, the base 21 limits the lower position of the piezoelectric motor 1, and the upper position of the second frame 32 is held by the balls. If there are deviations in the dimensions of the first frame 31, the second frame 32, and the base 21 from the set value due to manufacturing or assembly issues, they can be corrected to ensure levelness. For example, when the height of the first frame 31 and the second frame 32 is slightly higher than the design height, the upper elastic sheet 611 will still maintain contact with the balls due to the inherent rigidity, causing the upper elastic sheet 611 to deform upward. However, the restoring force of the elastic sheet itself will provide a downward force on the balls, thereby holding the second frame 32 within the housing 22 and on the base 21.

In another scenario, when the actual height of the second frame 32 is slightly lower than the design height, it will result in that during the pre-pressing process of the upper elastic sheet 611 and the pressure plate 222, although the height of the second frame 32 is slightly lower than the design height, the upper elastic sheet 611 will still maintain contact with the balls due to the inherent rigidity, and the restoring force of the upper elastic sheet 611 itself will still provide a downward force on the balls, thereby holding the second frame 32 within the housing 22 and on the base 21.

Referring to FIG. 4A, the number of the first side wall balls 510 provided on the base side plate 213 is three, and the connecting lines form an isosceles triangle. The isosceles triangular area formed by the first side wall balls 510 corresponds to the first piezoelectric friction head 411 on the opposite side. The first piezoelectric vibrator 410 undergoes extension/contraction or deformation during its motion stroke, causing the first piezoelectric friction head 411 to tilt in an elliptical manner during the telescoping process of the first piezoelectric vibrator 410. Consequently, this makes the first piezoelectric friction head 411 generate a tilting moment on the inner side wall of the base during its motion trajectory. The arrangement of multiple first side wall balls 510 can disperse the tilting moment, making the overall structure more stable.

FIG. 4A shows a projection view of the piezoelectric motor 1 of the present application along a certain direction. The three base side wall ball grooves 2120 are located on one side of the base side plate 213. This ensures that when the first frame 31 and the base 21 are connected through the first side wall balls 510, the supporting pressure force on the side can be evenly transmitted to the plane formed by the first side wall balls 510, avoiding excessive supporting pressure force on a single ball, which could cause reliability issues. Excessive supporting pressure force could also lead to material deformation, affecting the performance of the piezoelectric motor 1.

Still referring to FIG. 4A, a projection view of the piezoelectric motor 1 of the present application along a certain direction is shown. In one embodiment of the present application, the piezoelectric motor 1 generates an elliptical trajectory on a plane or further on a plane parallel to the third direction, as represented by the elliptical trajectory line with arrows in the figure. Referring to the X-X projection view in FIG. 4A, it illustrates that during at least a portion of the entire stroke □ the force supplied by the first piezoelectric actuator 41 of the piezoelectric motor 1 to the side of the first frame 31 is not perpendicular thereto, and the situation that the abutting force of the piezoelectric motor 1 on the first frame 31 will be tilted may occur during the complete elliptical trajectory.

To reduce the risk of tilting and improve the reliability of motor operation, it is necessary to ensure that the piezoelectric motor 1 maintains good parallelism throughout the entire stroke, preventing tilting. In order to reduce the occurrence of this phenomenon, refer to FIG. 4A, the upper and lower parts of the Y-Y projection view show the pressing force of the drive end of the piezoelectric motor 1 in the instantaneous state of the entire motion trajectory and the trajectory of the pressing force throughout the entire stroke. Specifically, according to one embodiment of the present application, in a certain projection view, the driving trajectory 9A of the drive end of the piezoelectric motor 1 always remains within the connection lines area 19A of the base side wall ball grooves 2120 during the driving stroke of the piezoelectric motor 1. On the other hand, the driving trajectory 9A can also be considered as the driving trajectory of the first piezoelectric friction head 411. Therefore, it ensures that during the entire motion process of the piezoelectric motor 1, the abutting force of the first friction head 411 on the first frame 31 is always dispersed by the plane formed by the three first side wall balls 510, ensuring that the first frame 31 remains stable during motion, and guaranteeing the operation reliability of the piezoelectric motor 1.

As shown in FIG. 4A illustrating a projection view of the piezoelectric motor 1 of the present application along a certain direction, the first piezoelectric actuator 41 is installed on the base side plate 213 opposite to the base side plate 213 where the base side wall ball grooves 2120 are installed. In such more specifically, in the projection view facing the base side plate 213, the first piezoelectric actuator 41 is located between the higher and lower ball grooves of the base side wall ball grooves 2120. This ensures that during the motion of the first piezoelectric actuator 41, the ball supporting area formed by one upper base side wall ball groove 2120 and two lower base side wall ball grooves 2120 is always larger than the driving area 9A of the first piezoelectric actuator 41, reducing the generation of tilting moment and preventing tilting of the outer edge of the base 21 and the first frame 31 due to the force application range of the piezoelectric actuator 40 exceeding the ball supporting range.

As shown in FIG. 4B, another variant embodiment of the piezoelectric motor 1 of the present application is shown in a projection view along a certain direction. In one embodiment of the present application, the piezoelectric motor 1 may adopt a reciprocating stick-slip piezoelectric motor 1, which may have multiple displacements compared to the original state. Referring to the Z-Z projection view in FIG. 4B, the upper and lower parts show the instantaneous state position of the drive end of the piezoelectric motor 1 and its range during the entire motion trajectory. The pressing force of the drive end of the piezoelectric motor 1 on the first frame 31 may be tilted in a unit cycle, which can easily cause tilting moment and tilt the relative position of the first frame 31 relative to the base 21. Since the reciprocating motion of the piezoelectric motor 1 drives the first frame 31 to move, although it is a reciprocating motion, the deformation of the piezoelectric material does not always occur uniformly, and when the stick-slip motor moves upwards and leaves the driven component, there is always an issue of tilt angle. Therefore, during at least one part of the entire motion trajectory, the force of the first piezoelectric actuator 41 on the first frame 31 not only has a deflection but also the endpoint of the force will move. To reduce the occurrence of this phenomenon, in this solution, the first piezoelectric actuator 41 is at the same distance from an upper base side wall ball groove 2120 and from two lower base side wall ball grooves 2120, that is, the three base side wall ball grooves 2120 form an equilateral triangle on the side. Referring to the upper part of the Y-Y projection view in FIG. 4B, it shows the entire motion trajectory 9B of the drive end of the stick-slip piezoelectric motor 1, indicating that during the entire stroke, the pressing force of the stick-slip piezoelectric motor 1 is greater than that of the actual stroke requirement of the piezoelectric motor 1 and has a certain degree of tilt.

Referring to the multiple dashed lines in the motion trajectory 9B of the drive end of the stick-slip piezoelectric motor 1, the motion trajectory 9B can also be considered as the abutting trajectory of the first piezoelectric friction head 411 relative to the first frame 31. When the pressing force exceeds the connection lines area 19B of the three base side wall ball grooves 2120, it can easily cause the first frame 31 to tilt. Referring to the Y-Y projection view in FIG. 4B, the base side wall ball grooves 2120 form an equilateral triangle, and the center of gravity of the equilateral triangle is consistent with its center. Therefore, points within a certain range from the center of the equilateral triangle can be considered as the abutting state of the first piezoelectric friction head 411 relative to the first frame 31, represented by circles of different sizes. Regardless of the pressing state, the equilateral triangle arrangement the three base side wall ball grooves 2120 enables the balls therein to more readily dissipate the tilting moment generated by the first piezoelectric friction head 411 relative to the first frame 31.

In other words, in a certain projection, the connection lines of the side wall balls form an isosceles or equilateral triangular area. When the piezoelectric actuator 40 of the piezoelectric motor 1 is in an instantaneous state of stick-slip pressing force, regardless of where the pressing force is, it is easier to disperse and balance the moment relative to the support of each ball. Referring to the Y-Y projection view in FIG. 4B, adopting an equilateral triangle arrangement makes it easier to reduce tilting moment.

In summary, the piezoelectric actuator requires the friction head to abut against an abutted component to drive. During the vibration of the piezoelectric vibrator, the friction head may inevitably detach from the abutted component, thereby causing the friction head to tilt from the abutted component. Therefore, reducing tilting is key for improving the stability of the piezoelectric actuator during operation and enhancing the reliability of the piezoelectric motor. The above technical solutions can be summarized into one technical solution, in such the housing 22 and the base 21 can be considered as the fixing assembly, and the first, second, and third frames can be considered as the movable assembly 30. The present invention proposes a piezoelectric motor 1 comprising a fixing assembly 20, a movable assembly 30 movably connected to the fixing assembly, and a piezoelectric actuator 40 abutting against the movable assembly 30. The movable assembly 30 is supported on the fixing assembly 20 by balls 50 provided on one side of the movable assembly 30. The balls 50 form at least one plane, and the piezoelectric actuator 40 is located on the plane. This arrangement reduces the tilting moment generated by the piezoelectric actuator 40 on the movable assembly 30.

On the other hand, the balls 50 comprise side wall balls. The side wall balls are provided between the outer side of the movable assembly 30 and the inner side of the fixing assembly 20. The piezoelectric actuator 40 abuts against the movable assembly 30 and is located on the opposite side of the side wall balls.

On the other hand, referring to the previous part of this application, there exists an inclination of the force provided by the drive end of the piezoelectric actuator 40 to the movable assembly 30 during the entire motion trajectory relative to the plane formed by the connection lines of the balls, so that the side wall balls arranged according to the embodiment of the present invention effectively reduce tilting. Referring to FIGS. 4A-4B, when the drive end of the piezoelectric actuator 40 provides a pressing force perpendicular to the frame 30, there is no tilting moment of the drive end on the balls. Therefore, in the embodiment of the present invention, there exists an inclination of the force provided by the drive end of the piezoelectric actuator 40 to the movable assembly 30 during the entire motion trajectory relative to the plane formed by the connection lines of the balls, so that the tilting moment generated by the drive end of the piezoelectric actuator 40 on the movable assembly 30 can be reduced.

In summary, the above content can be summarized as the optimization of the arrangement of the piezoelectric actuator 40 and the balls in this application. The piezoelectric actuator 40 abuts against the movable assembly 30, and the movable assembly 30 is supported on the fixing assembly 20 by balls provided on one side of the movable assembly 30. The balls 50 form at least one supporting plane, and the drive end of the piezoelectric actuator 40 acts on the supporting plane formed by the balls 50.

In detail, the movable assembly 30 is supported on the base by side wall balls provided on one side of the movable assembly 30, the balls form at least one plane, and the piezoelectric actuator 40 is located within the projection area of the plane area formed by the balls in a certain direction. This technical solution indicates that by placing the piezoelectric actuator 40 within the plane area of the balls, the tilting moment of the piezoelectric actuator 40 on the movable assembly 30 relative to the base 21 can be reduced.

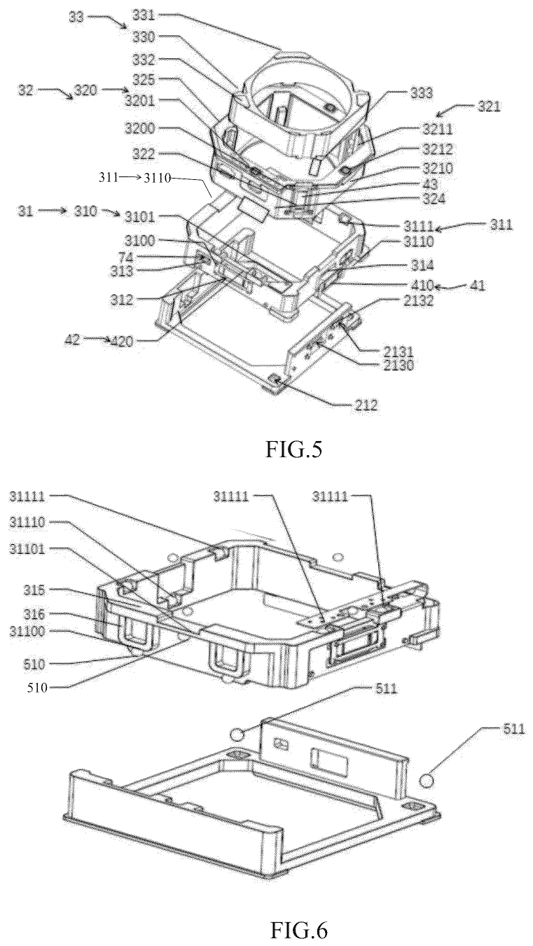

Referring to FIGS. 5, 6, and 7, the first frame mounting portion 310 comprises a first frame first mounting structure 3100, in such the first frame first mounting structure 3100 is arranged on the outer side surface of the first frame 31, the first frame first mounting structure 3100 is specifically a pair of mounting posts. A first frame second mounting structure 3101 is arranged on the upper surface of the first frame 31, and the first frame second mounting structure 3101 is a set of mounting posts. The first frame first mounting structure 3100 is used to fix the second piezoelectric actuator 42 or the circuit board 10 installed with the second piezoelectric actuator 42 and/or the second elastic sheet 622. The first frame second mounting structure 3101 is used to fix the circuit board 10. The first frame first mounting structure 3100 is arranged on an outer side surface of the first frame 31, and the first frame second mounting structure 3101 is arranged on an upper surface of the first frame 31. Both the first frame first mounting structure 3100 and the first frame second mounting structure 3101 are a set of mounting posts, in such the first frame first mounting structure 3100 is connected to the second main body of the circuit board 10 by shaft-hole positioning, and the first frame second mounting structure 3101 is connected to the turning body 14 of the circuit board 10 by shaft-hole positioning, to fix the second main body 12 of the circuit board 10.

The first frame ball grooves 311 further comprise first frame outer ball grooves 3110 and first frame inner ball grooves 3111, in such the first frame outer ball grooves 3110 are formed on the outer surface of the first frame 31, and the first frame inner ball grooves 3111 are provided on the inner surface of the first frame 31, in such the first frame outer ball grooves 3110, the base ball grooves 212, and the balls 50 cooperate with each other, so that the first frame 31 and the base 21 have the freedom of movement in the first direction under the action of the first piezoelectric actuator 41. The first frame outer ball grooves 3110 further comprise first frame first height outer ball grooves 31100 formed at the bottom of the first frame 31 and a first frame second height outer ball groove 31101 formed at the top extension portion 315, in such the first frame second height outer ball groove 31101 is arranged at a higher position on the first frame 31 than the first frame first height outer ball grooves 31100. This ensures that when balls are placed in the ball grooves of the first frame 31, the movement is more stable and rotational moment is less likely to occur. The specific function can be referred to the content of FIGS. 4A-4B regarding the reduction of tilting moment by planar balls, which will not be repeated here.

According to the embodiment of the present invention, the way that the piezoelectric motor is provided with side wall balls and end face balls can be obtained. The driving direction of the drive end of the piezoelectric actuator is perpendicular to the supporting plane formed by the side wall balls, and the driving direction of the drive end of the piezoelectric actuator is parallel to the supporting plane formed by the end face balls, thereby ensuring smoother driving of the piezoelectric motor, which can not only reduce the tilting moment, but also ensure better planar motion.

The first frame 31 further has a first frame first through-hole 312 and a first frame second through-hole 313, in such the first frame first through-hole 312 is formed on one side of the first frame 31, and the first frame second through-hole 313 is formed near the first frame first through-hole 312. The first frame first through-hole 312 is arranged in the center of the first frame 31. In one embodiment of the present application, the first frame first through-hole 312 according to the embodiment of the present invention is used to allow the second piezoelectric actuator 42 installed on the first frame 31 to extend into it. The second piezoelectric friction head 421 of the second piezoelectric actuator 42 can extend into the first frame 31 and abut against the second frame 32.

In one embodiment of the present application, the first frame second through-hole 313 is used to accommodate the second position sensor 74 or a magnet. In some embodiments, the second position sensor 74 detects the magnitude of magnetic flux to determine the relative position of the second frame 32.

Referring to FIG. 6, in this embodiment, the first frame first height outer ball grooves 31100 are formed at the lower end of the first frame 31. In this embodiment, four first frame first height outer ball grooves 31100 at the same height are preferred. In such, two of the first frame first height outer ball grooves 31100 are formed at two bottom corners of the first frame 31, and two of the first frame first height outer ball grooves 31100 are formed at the bottom of the side wall extension portion 316 on one side of the first frame 31. The first frame second height outer ball grooves 31101 are formed at the top extension portion 315 of the first frame 31. The first frame second height outer ball grooves 31101 and at least two first frame first height outer ball grooves 31100 are formed on the same side of the first frame 31. This arrangement makes the at least two first frame first height outer ball grooves 31100 and one first frame second height outer ball groove 31101 on the same side form a triangle support, and when the base side plate 213 and the first frame 31 are supported by balls, the triangle support arrangement provides a rolling plane that ensures smoother movement and less likely to generate rotational moment. The specific function can be referred to the content of FIGS. 4A-4B regarding the reduction of tilting moment by planar balls, which will not be repeated here.

Referring to FIG. 6, in one embodiment of the present application, the number of the first frame first height outer ball groove 31100 is two, and the first frame second height outer ball groove 31101 is located in the middle of the connection line between two first frame first height outer ball grooves 31100 on the same side in a projection parallel to a third direction. Furthermore, the first frame second height outer ball groove 31101 is at the same distance from the adjacent first frame first height outer ball grooves 31100. This ensures that when the first frame 31 and the base 21 are connected by balls, the supporting pressure on the side can be evenly transmitted to the surface, avoiding excessive pressure on a single ball groove, which could cause reliability issues, deformation, etc. The specific function can be referred to the content of FIGS. 4A-4B regarding the reduction of tilting moment by planar balls, which will not be repeated here.

Referring to FIG. 6, the first frame inner ball grooves 3111 are connected to the second frame 32, in such the first frame inner ball grooves 3111 further comprise first frame first height inner ball grooves 31110 and first frame second height inner ball grooves 31111, in such the first frame second height inner ball grooves 31111 are arranged at a higher position than the first frame first height inner ball grooves 31110. This ensures that when balls are placed in ball grooves at different heights after the first frame 31 is connected to the second frame 32, there will be moments of different heights, making the movement more stable and less likely to generate rotational moment. The specific function can be referred to the content of FIGS. 4A-4B regarding the reduction of tilting moment by planar balls, which will not be repeated here.

The first frame first height inner ball grooves 31110 and the first frame second height inner ball grooves 31111 can each be provided with one ball, thereby preventing two balls from interfering with each other during movement due to the number of balls in a single ball groove is greater than or equal to two. The specific function can be referred to the content of FIGS. 4A-4B regarding the reduction of tilting moment by planar balls, which will not be repeated here.

Referring to FIG. 7, according to the embodiment of the present invention, the first frame 31 has three or more first frame second height inner ball grooves 31111. In some embodiments, there are four first frame second height inner ball grooves 31111. Two of the second height inner ball grooves 31111 are formed on one inner wall on one side of the first frame 31, and the remaining second height inner ball grooves 31111 are formed on the inner wall on the opposite side of the first frame 31. In one embodiment of the present application, using four balls to form a rolling plane can increase the flatness during rolling. When the number of ball grooves is greater than three, a rolling plane can also be formed by three balls to ensure rolling flatness.

The number of the first frame first height inner ball groove 31110 is one, and the first frame first height inner ball groove 31110 is arranged in the middle of the connection line between the first frame second height inner ball grooves 31111 in the third direction projection and is lower than the first frame second height inner ball grooves 31111. Furthermore, the first frame first height inner ball groove 31110 is at the same distance from the adjacent first frame second height inner ball grooves 31111. This ensures that when the first frame 31 and the second frame 32 are connected, the supporting pressure on the side can be evenly transmitted, avoiding excessive pressure on a single ball groove, which could cause reliability issues, deformation, etc.

Referring to FIG. 7 and FIG. 10, the second frame 32 further comprises a second frame mounting portion 320 and a second frame top extension portion 325. The second frame mounting portion 320 is provided on the side wall surface of the second frame 32 and is used to install the third piezoelectric actuator 43, the third elastic sheet 623, and/or the circuit board 10. The second frame mounting portion 320 comprises a second frame first mounting structure 3200, in such the second frame first mounting structure 3200 is arranged on the outer surface of the second frame 32. In some specific embodiments, the second frame first mounting structure 3200 is located at the outer corner of the second frame 32. The second frame first mounting structure 3200 is used to fix the third piezoelectric actuator 43, the third elastic sheet 623, and the circuit board 10. The second frame second mounting structure 3201 is provided on the top surface of the second frame 32 and specifically as at least one mounting post for fixing the third main body 13 of the circuit board 10.

Referring to FIG. 7, the second frame ball grooves 321 are further divided into second frame outer ball grooves 3210, second frame inner ball grooves 3211, and second frame upper ball grooves 3212 in such the second frame outer ball grooves 3210 are provided on the outer surface of the second frame 32, the second frame inner ball grooves 3211 are provided on the inner surface of the second frame 32, and the second frame upper ball grooves 3212 are provided on the upper surface of the second frame 32. Using ball grooves provided on different surfaces can reduce the increase in size caused by stacking balls on a single side and also utilize the molding space of different surfaces, ensuring that the ball grooves do not shrink severely due to gathering together during injection molding. On the other hand, the different balls are subjected to forces to ensure that the second frame 32 is more securely installed.

Referring to FIG. 7, the second frame outer ball grooves 3210 cooperate with the first frame inner ball grooves 3111, so that the second frame 32 and the first frame 31 have freedom of movement in the second direction between them. The second frame outer ball grooves 3210 also comprise second frame first height outer ball grooves 32100 and second frame second height outer ball grooves 32101, in such the second frame second height outer ball grooves 32101 are arranged at a higher position on the second frame 32 than the second frame first height outer ball grooves 32100 arranged at the second frame 32. Balls at different heights ensure smoother and more planar movement when placed in the ball grooves, and less likely to generate rotational moment. The specific function can be referred to the content of FIGS. 4A-4B regarding the reduction of tilting moment by planar balls, which will not be repeated here.

At least three second frame second height outer ball grooves 32101 are formed on the outer side of the second frame 32. In this embodiment, four second frame second height outer ball grooves 32101 at the same height are preferred. In such, two of the second frame second height outer ball grooves 32101 are formed on the outer surface of one side of the second frame 32, and the other two are formed on the outer surface of the opposite side of the second frame 32. The specific function can be referred to the content of FIGS. 4A-4B regarding the reduction of tilting moment by planar balls, which will not be repeated here.

For ease of understanding, in one embodiment of the present application, the two second frame second height outer ball grooves 32101 near the second piezoelectric actuator 42 on the left and right sides are at same distance from the two second frame second height outer ball grooves 32101 on the opposite side, forming an isosceles trapezoid. This ensures that when the second frame second height outer ball grooves 32101 is supported, the supporting pressure is evenly transmitted, avoiding excessive pressure on a single ball groove, which could cause reliability issues, deformation, etc. On the other hand, the distance between the two second frame outer ball grooves 32101 near the second piezoelectric actuator 42 is greater than the length of the second piezoelectric actuator 42. This ensures that during the operation of the second piezoelectric actuator 42, the deformation caused by overall vibration is always supported by the two second frame outer ball grooves 32101 located outside the piezoelectric actuator, preventing the vibration amplitude of the piezoelectric actuator from exceeding the supporting distance between the two second frame outer ball grooves 32101, which could cause the edge of the second frame 32 to vibrate and warp. The specific function can be referred to the content of FIGS. 4A-4B regarding the reduction of tilting moment by planar balls, which will not be repeated here.

For ease of summary, the balls arranged on the outer side of the piezoelectric actuator in the embodiment of the present invention can be summarized as the piezoelectric actuator same-side balls, and the two piezoelectric actuator same-side balls are arranged on the upper side of the piezoelectric actuator. This can increase the flatness of the piezoelectric actuator during driving.

Similarly, side wall balls between the first frame 31 and the base 21 are also provided between the first frame 31 and the second frame 32, in such the side wall balls between the first frame 31 and the second frame 32 are placed in the first frame first height inner ball grooves 31110 and the first frame second height inner ball grooves 31111, and they have the same functions and effects as described in the previous section. The specific function can be referred to the content of FIGS. 4A-4B regarding the reduction of tilting moment by planar balls, which will not be repeated here.

Referring to FIG. 10, the number of the second frame first height outer ball groove 32100 is one, and the second frame first height outer ball groove 32100 is located in the middle of the connection line between two second frame second height outer ball grooves 32101 on the same side in the third direction projection. Furthermore, the second frame first height outer ball groove 32100 is at the same distance from the adjacent second frame second height outer ball grooves 32101. This ensures that when the first frame 31 and the second frame 32 are connected by balls, the supporting pressure on the side can be evenly transmitted to the surface, avoiding excessive pressure on a single ball groove, which could cause reliability issues, deformation, etc. The specific function can be referred to the content of FIGS. 4A-4B regarding the reduction of tilting moment by planar balls, which will not be repeated here.

The second frame inner ball grooves 3211 are two ball grooves extending along the optical axis direction and located at opposite corners inside the second frame 32. The third frame 33 is movably connected within the second frame 32 through the second frame inner ball grooves 3211 and the balls placed in the ball grooves 3211 under the driving effect of the third piezoelectric actuator 43, and the third frame 33 has freedom of movement in the third direction relative to the second frame 32, that is, the freedom to move along the optical axis direction.

Referring to FIG. 7, the second frame 32 further has a second frame first through-hole 322, in such the second frame first through-hole 322 is located at one corner of the second frame 32, and the second frame first mounting structure 3200 is located around the second frame first through-hole 322. In one embodiment of the present application, the second frame first through-hole 322 is used to allow the third actuator 43 installed on the second frame 32 to extend into it. The second piezoelectric friction head 421 of the second piezoelectric actuator 42 can extend into the second frame 32 and abut against the third friction plate 333 provided on the outer side wall of the third frame 33.

Referring to FIG. 11, a circuit board 10 for fixing the frame of the anti-shake motor will be described. Referring to FIG. 11, a circuit board 10, comprising a first main body 11, a second main body 12, and a third main body 13. The plane where the second main body 12 is located, is orthogonal to the plane where the first main body 11 is located; the plane where the third main body 13 is located is not parallel to the planes where the first main body 11 and the second main body 12 are located; a turning body 14 is provided between at least two main bodies to provide planar extension between different main bodies. In such, the turning body 14 comprises a first turning body 140 and a second turning body 141. The first turning body 140 connects the first main body 11 and the second main body 12, and the second turning body 141 connects the second main body 12. The second turning body 141 is installed on the upper surface of the second frame 32. The second turning body 141 is folded in at least two different directions, so that the upper surface of the second turning body 141 has at least two degrees of freedom relative to the side of the second main body 12.

Referring to FIG. 5, according to the embodiment of the present invention, the third frame 33 further comprises third frame ball grooves 330, a third frame avoidance portion 331, a third friction plate 333 provided on the side wall of the third frame 33, and a third frame mounting portion 332, in such the third frame ball grooves 330 are formed on the side walls of the corners on the opposite sides of the third frame 33 and the third frame ball grooves 330 extend along the third direction, that is, extend along the optical axis direction. Therefore, the third frame 33 can be movably connected within the second frame 32 through the third frame ball grooves 330 and the balls. By arranging ball grooves on the opposite sides, the tilting moment caused by single-side ball support can be prevented, ensuring that the third frame maintains good vertical linear performance when moving along the optical axis direction. The third frame avoidance portion 331 is formed on the side wall of one corner of the third frame 33. In one embodiment of the present application, the third frame avoidance portion 331 is a groove provided on the side wall of the third frame 33. The third position sensor 76 is arranged in the third frame avoidance portion 331 to detect the position change of the third frame 33 relative to the second frame 32. The third frame mounting portion 332 is provided on the top surface of the third frame 33. In one embodiment of the present application, the third frame mounting portion 332 is specifically a set of positioning holes or grooves for assembling the circuit board 10, especially for assembling the third main body 13 of the circuit board. The driving position of the first piezoelectric actuator 41 is determined by the first position sensor 72. The first position sensor 72 is located on one side of the first piezoelectric vibrator 410 and the first position sensor 72 can sense the displacement of the movable assembly 30.

Furthermore, the second piezoelectric actuator 42 comprises a second piezoelectric vibrator 420 and a second piezoelectric friction head 421. The second piezoelectric vibrator 420 is rectangular and strip-shaped, and the long side of the rectangle of the second piezoelectric vibrator 420 is perpendicular to the optical axis. The second piezoelectric vibrator 420 is provided on the second frame 32 and the second piezoelectric vibrator 420 is located on the second frame 32. The side surface of the second piezoelectric vibrator 420 facing the lens assembly is the first surface of the second piezoelectric vibrator 420, and the side surface of the second piezoelectric vibrator 420 away from the lens assembly is the second surface of the second piezoelectric vibrator 420. The first surface and the second surface are opposite to each other.

Referring to FIGS. 5, 7, and 10, the first surface of the second piezoelectric vibrator 420 has a second piezoelectric friction head 421. The second piezoelectric friction head 421 is located at the center of the first surface of the second piezoelectric vibrator 420. A second friction plate 324 is provided on the other side of the second piezoelectric friction head 421. The second friction plate 324 is a rectangular plate structure, and the second friction plate 324 and the first surface of the second piezoelectric vibrator 420 are arranged in parallel. The second piezoelectric friction head 421 is located at the center of the second friction plate 324, ensuring that the second friction head 421 and the second friction plate 324 are subjected to a more evenly force. The second piezoelectric friction head 421, the second piezoelectric vibrator 420, and the second friction plate 324 are tightly abut against each other, generating friction to drive. The second surface of the second piezoelectric vibrator 420 is attached to the second main body 12 of the circuit board 10, and the second surface of the second piezoelectric vibrator 420 corresponds to the second pass-through hole 121 of the second main body 12. The second pass-through hole 121 can prevent interference with the second piezoelectric vibrator 420.

Referring to FIG. 2, in one embodiment of the present application, the housing 22 further comprises a housing body 221 and a pressure plate 222. In such the pressure plate 222 is installed at the lower end of the housing body 221, in such both the upper and lower surfaces of the pressure plate 222 are provided with positioning portions, such as positioning holes or grooves, to better connect with the housing body 221. The transverse elastic sheet 61 comprises an upper elastic sheet 611. The upper elastic sheet 611 is connected to the lower side of the pressure plate 222. The lower surface of the upper elastic sheet 611 abuts against the balls placed in the second frame upper ball grooves 3212, ensuring that the transverse elastic sheet 61, as a force-applying component, always provides a pre-pressure force to the balls placed in the second frame upper ball grooves 3212. This ensures that the pre-pressure force of the elastic sheet and gravity as the overall supporting force in the third direction after the second frame 32, the first frame 31 and the base 21 are assembled, ensuring that the assembly height is always maintained and preventing the first frame 31 and the second frame 32 from tilting relative to the base 21.

In another embodiment, the transverse elastic sheet 61 further comprises a lower elastic sheet, in such the lower elastic sheet can be installed on the lower side of the face balls between the first frame 31 and the base 21. Through the combined action of the upper and lower elastic sheets, the movable assembly 30 is provided within the fixing assembly 20 by greater elastic potential energy and position accuracy, achieving a centered arrangement of the movable assembly 30.

Referring to FIG. 2, a second elastic sheet 622 is provided to correspond to the area where the second piezoelectric actuator 42 is installed on the second main body 12. The second elastic sheet 622 comprises a second elastic sheet pre-pressure portion 6220, in such the second elastic sheet pre-pressure portion 6220 is arranged in the center of the second elastic sheet 622, and the second elastic sheet pre-pressure portion 6220 is arranged on the back of the second piezoelectric vibrator 420. The second elastic sheet pre-pressure portion 6220 provides a pre-pressure force on the back of the second piezoelectric vibrator 420. A second elastic sheet first through-hole 6221 is formed in the middle of the second elastic sheet pre-pressure portion 6220, in such four second elastic sheet connecting arms 6222 are arranged around the second elastic sheet pre-pressure portion 6220, the four second elastic sheet connecting arms 6222 provide support for the second piezoelectric vibrator 420 in the plane direction. The second elastic sheet first through-hole 6221 corresponds to the back of the second piezoelectric vibrator 420, the second elastic sheet first through-hole 6221 serves to avoid the deformation of the back of the second piezoelectric vibrator 420, preventing the second piezoelectric vibrator 420 from interfering with the second elastic sheet 622 during operation, thereby increasing the reliability of the piezoelectric motor.

Additionally, the second elastic sheet connecting arm 6222 comprises a pair of second elastic sheet longitudinal connecting arms 62220 extending along the optical axis direction and a pair of second elastic sheet transverse connecting arms 62221 extending perpendicular to the optical axis direction, in such the second elastic sheet longitudinal connecting arms 62220 and the second elastic sheet transverse connecting arms 62221 are integrally extended with each other to form a rectangular frame body to pre-press and support the second main body 12 of the circuit board 10, thereby providing a rectangular frame pre-pressure force on the back of the second piezoelectric vibrator 420 to support the second piezoelectric vibrator 420, ensuring that the second piezoelectric friction head 421 on the second piezoelectric vibrator 420 always abuts against the second friction plate 324.

The second elastic sheet pre-pressure portion 6220 has second elastic sheet side portions 6223 integrally extending from both sides, in such two second elastic sheet side portions 6223 are respectively formed with a second elastic sheet second through-hole 6224 and a second elastic sheet third through-hole 6225, in such the second elastic sheet second through-hole 6224 and the second elastic sheet third through-hole 6225 have the same size. The second elastic sheet side portions 6223 are provided with mounting holes, allowing the second elastic sheet 622 to be fixed to the first frame 31 through the mounting holes on the second elastic sheet side portions 6223. On the other hand, by providing through-holes on both sides of the second elastic sheet pre-pressure portion 6220, the movable margin of the second elastic sheet pre-pressure portion 6220 can be increased.

The second elastic sheet 622 is elastic. The second elastic sheet longitudinal connecting arms 62220 separate the portion between the second elastic sheet second through-hole 6224, the second elastic sheet third through-hole 6225, and the second elastic sheet first through-hole 6221 from one another. The through-holes reduce the deformation coefficient of the elastic sheet, and correspondingly increasing the elastic potential energy of the second elastic sheet longitudinal connecting arms 62220.

It can be understood that a pre-pressure force provided by the second elastic sheet 622 allows the piezoelectric actuator 41 to move freely, but it is always subjected to the pre-pressure force of the second elastic sheet 622 which is perpendicular to the direction of motion to maintain the abutting state required for driving the second piezoelectric actuator 42.

Specifically, the area of the second elastic sheet first through-hole 6221 is at least twice greater than the area of the second elastic sheet second through-hole 6224, thereby increasing the recovery force of the second elastic sheet 622 and always maintaining the abutting state required for the second piezoelectric actuator 42 to drive.

The four corners of the second elastic sheet side portions 6223 are each formed with a second elastic sheet positioning hole 62230. The second elastic sheet positioning hole 62230 is a through-hole structure, allowing the second elastic sheet 622 to be easily installed on the first frame 31. Additionally, the second elastic sheet fixing holes 62230 are separate from the positioning holes on the second positioning portion 123 of the circuit board 10. Therefore, the fixing relationship between the second elastic sheet 622 and the first frame 31 is not affected by the assembly of the circuit board 10. Furthermore, the dimensional variations caused by the vibration of the second piezoelectric actuator 42 during operation will not affect the assembly stability of the second elastic sheet 622, ensuring a relatively stable connection between the second elastic sheet 622 and the base side plate 213.

In summary, the second elastic sheet 622 according to the embodiment of the present invention can serve to fix and limit the second piezoelectric vibrator 420 while also providing a certain pre-pressure force.

To simplify the description, similarly, the third piezoelectric vibrator 430 is in the shape of a rectangular strip, and the long side of the third piezoelectric vibrator 430 extends along the optical axis direction. The third piezoelectric vibrator 430 is arranged on the third main body 13 of the circuit board 10, above the third elastic sheet 623. The third elastic sheet 623 is arranged on the side wall of the second frame 32. The side surface of the third piezoelectric vibrator 430 facing the lens assembly or the third frame 33 is the first surface of the third piezoelectric vibrator 430, and the side surface of the third piezoelectric vibrator 430 away from the lens assembly or the third frame 33 is the second surface of the third piezoelectric vibrator 430. The first surface and the second surface are opposite to each other. Referring to FIGS. 7, 8, and 9, the first surface of the third piezoelectric vibrator 430 has a third piezoelectric friction head 431. The third piezoelectric friction head 431 is located at the center of the first surface of the third piezoelectric vibrator 430. In the area of a corner side wall of the third frame 33 facing the third piezoelectric friction head 431, a third friction plate 333 is provided extending along the optical axis direction. The third friction plate 333 is a rectangular plate structure and the third friction plate 333 is parallel to the first surface of the third piezoelectric vibrator 430. The third piezoelectric friction head 431 is facing the center area of the third friction plate 333, ensuring that the third friction head 431 and the third friction plate 333 are subjected to a more evenly force. The third piezoelectric friction head 431 tightly abuts against the third friction plate 333, generating friction to drive. The second surface of the third piezoelectric vibrator 430 abuts against the second frame 32. In some optional embodiments, the second surface of the third piezoelectric vibrator 430 is installed on the third elastic sheet 623, and the third elastic sheet 623 is further provided at the outer corner of the second frame 32. The third friction plate 333 can be installed on the third frame mounting portion 332.

Similar to the structures of the first elastic sheet 621 and the second elastic sheet 622, the third elastic sheet 623 also comprises a third elastic sheet pre-pressure portion 6230, a third elastic sheet first through-hole 6231, third elastic sheet connecting arms 6232, third elastic sheet side portions 6233, a third elastic sheet second through-hole 6234 and a third elastic sheet third through-hole 6235, in such the relationships between these components can be referred to the descriptions of the first elastic sheet 621 and the second elastic sheet 622.

Taking the first piezoelectric actuator 41 as an example, when the first piezoelectric actuator 41 is excited by a power supply/voltage, the first piezoelectric vibrator 410 undergoes different surface changes in a standing wave or traveling wave state in the first direction, thereby driving the first piezoelectric friction head 411 to produce reciprocating swing or elliptical motion in the first direction. Due to the frictional contact between the first piezoelectric friction head 411 and the first friction plate 314, the first friction plate 314 is driven to move. Specifically, when the first piezoelectric actuator 41 is excited by one type of power supply, the first piezoelectric vibrator 410 produces a telescoping motion in the first direction, and the first piezoelectric friction head 411, driven by the first piezoelectric vibrator 410, undergoes reciprocating swing motion in the first direction, thereby driving the first friction plate 314 to move in the first direction. When the first piezoelectric actuator 41 is excited by another type of power supply/voltage, the first piezoelectric vibrator 410 produces a telescoping motion in the first direction and a stretching motion in the second direction, and the first piezoelectric vibrator 410 drives the first piezoelectric friction head 411 to undergo elliptical motion in the first plane, thereby driving the first friction plate 314 to move in the first direction. Therefore, the first, second, and third piezoelectric actuators (41, 42, 43) have degrees of freedom in the first, second, and third directions respectively, enabling them to drive the movable assembly 30 to move in the first, second, and third directions, adjusting the relative position between the lens assembly and the photosensitive assembly to achieve optical anti-shake. In such, each elastic sheet of each piezoelectric actuator also provides a certain supporting function, as shown in FIG. 2, providing a pre-pressure force perpendicular to the driving direction for the first piezoelectric actuator 41, and also providing a pre-pressure force perpendicular to the driving direction for the second piezoelectric actuator 42, thereby improving the movement stability of the piezoelectric actuator during optical anti-shake and enhancing imaging quality.

Referring to FIG. 11, the present application proposes a circuit board for connecting different driving frames of an anti-shake motor. In one embodiment of the present application, the circuit board 10 is arranged with different main bodies, so that the circuit board 10 is installed on different frames of the motor after being bent or turned multiple times. The turning process of the circuit board 10 can increase the movable stroke of the circuit board 10, and the turning body 14 provided on the circuit board 10 can provide a certain reset function.

Referring to FIG. 11, the first main body 11, the second main body 12, and the third main body 13 of the circuit board 10 are respectively fixed on different surfaces of the motor frame. The different main bodies of the circuit board 10 provide an installation foundation for the anti-shake motor and are electrically connected to the anti-shake motor.

Continuing from the previous description, the turning body 14 comprises a first turning body 140 and a second turning body 141. The first turning body 140 connects the first main body 11 and the second main body 12, and the second turning body 141 connects the second main body 12. The second turning body 141 is installed on the upper surface of the second frame 32. The second turning body 141 is folded in at least two different directions, so that the upper surface of the second turning body 141 has at least two degrees of freedom relative to the side of the second main body 12. Referring to FIGS. 7 and 8, the turning body 14 comprises a first turning body 140 and a second turning body 141. The first turning body 140 is arranged between the first main body 11 and the second main body 12, that is, the first main body 11 is flipped in a direction perpendicular to the plane of the first main body to form the second main body 12.

The second turning body 141 is folded in at least two different directions, allowing the upper surface of the second turning body 141 to be installed on the upper surface of the second frame 32. The second turning body 141 has at least two degrees of freedom relative to the second main body 12, that is, the second main body 12 is flipped in two or three directions to the upper surface of the second frame 32. Specifically, the second turning body 141 comprises a first turning portion 1410, a second turning portion 1411, and a third turning portion 1412, in such the first turning portion 1410, the second turning portion 1411, and the third turning portion 1412 respectively undergo flexible bending process, which can buffer the main bodies of the circuit board 10 and provide a certain restoring force, giving the movable assembly 30 a degree of freedom for movement.

In one embodiment of the present application, the second turning body 141 is connected to the upper surface of the second frame 32, in such the second turning body 141 further comprises a first turning portion 1410, a second turning portion 1411, and a third turning portion 1412, in such the first turning portion 1410 and the second turning portion 1411 are orthogonal with each other, in such the first turning portion 1410 is located near the second main body 12 and the second turning portion 1411 is located near the third main body 13 to provide an extended plane between the second main body 12 and the third main body 13.

Referring to FIG. 11, the second turning body 141 comprises a second turning body mounting portion 143. The second turning body mounting portion 143 is installed on an upper surface of the second frame 32. The plane where the second turning body mounting portion 143 is located is parallel to an upper plane of the second frame 32, and the second turning body mounting portion 143 is fixedly connected to the upper surface of the second frame 32 to provide adjustment margin and increasing the movable stroke of the movable assembly 30.

Referring to FIG. 11, the second main body 12 and the third main body 13 are respectively formed with a second pass-through hole 121 and a third pass-through hole 131, in such the second main body 12 and the third main body 13 are plate-shaped. The second main body 12 further comprises a second mounting portion 120, second connecting arms 122 and a second positioning portion 123. The second mounting portion 120 is attached to an outer side of the second piezoelectric actuator 42, and the second mounting portion 120 is formed with a rectangular second pass-through hole 121 in the middle. The second mounting portion 120 is ring-shaped, and the second piezoelectric vibrator 420 can be attached to the solid ring portion of the second mounting portion 120. The rectangular opening of the second mounting portion 120 is arranged as a clearance on the back of the second piezoelectric vibrator 420, increasing the reliability of the piezoelectric motor 1 and preventing detachment caused by impact or vibration during motion. The deformation on the back of the second piezoelectric vibrator 420 is avoided by the rectangular opening in the middle of the second mounting portion 120, ensuring that the second piezoelectric vibrator 420 is firmly fixed to the second main body 12.

The first positioning portion 113 is fixedly connected to the side plate mounting portion 2132 of the base. The first positioning portion 113 serves to realize the attaching function for the first main body 11. The first positioning portion 113 is a plate-shaped structure with positioning holes, and the first positioning portion 113 is arranged on the outer side of the first mounting portion 110. Two first connecting arms 112 are flexible, and the first mounting portion 110 is integrally connected to the first positioning portion 113 of the first main body 11 through the two first connecting arms 112 on both sides. The first mounting portion 110 extends to the first positioning portion 113 through the first connecting arms 112 on both sides, and the first main body 11 is connected to the positioning posts on the outer surface of the base side plate 213 through the positioning holes, thereby improving the assembly accuracy of the camera module. The first connecting arms 112 can enable a certain margin adjustment when the first main body 11 assembles the first piezoelectric actuator 41.

Specifically, along the optical axis direction, the first mounting portion 110 does not extend integrally with the first main body 11. It can be understood that the first mounting portion 110 only extends to the first main body 11 through the two connecting arms 112 on the outer side. Therefore, relative to the first main body 11, the first mounting portion 110 has degrees of freedom not only in the direction of the extension of the two connecting arms, but also along the optical axis direction. Thus, the first mounting portion 110 has at least a degree of freedom perpendicular to the optical axis direction relative to the first positioning portion, meeting the movable margin required for the rotation and deflection of the friction head during the operation of the first piezoelectric vibrator 410.

The first elastic sheet 621 comprises a first elastic sheet pre-pressure portion 6210, in such the first elastic sheet pre-pressure portion 6210 is arranged in the middle of the first elastic sheet 621, and the first elastic sheet pre-pressure portion 6210 is located on the back of the first piezoelectric vibrator 410. The first elastic sheet pre-pressure portion 6210 provides a pre-pressure force on the back of the first piezoelectric vibrator 410. A first elastic sheet first through-hole 6211 is formed in the middle of the first elastic sheet pre-pressure portion 6210, in such four first elastic sheet connecting arms 6212 are arranged around the first elastic sheet pre-pressure portion 6210, the four first elastic sheet connecting arms 6212 provide support for the first piezoelectric vibrator 410 in the plane direction. The first elastic sheet first through-hole 6211 corresponds to the back of the first piezoelectric vibrator 410, and the first elastic sheet first through-hole 6211 serves to avoid the deformation of the back of the first piezoelectric vibrator 410, preventing the first piezoelectric vibrator 410 from interfering with the first elastic sheet 621 during operation, thereby increasing the reliability of the piezoelectric motor.

Referring to FIG. 11, the first mounting portion 110, the second mounting portion 120, and the third mounting portion 130 form structures with positioning hole. The first mounting portion 110, the second mounting portion 120, and the third mounting portion 130 are respectively fixed to the base side plate 213, the first frame 31, and the second frame 32 through the positioning holes.

Referring to FIG. 11, the first pass-through hole 111 and the second pass-through hole 121 are rectangular pass-through holes. The symmetry line of each rectangular pass-through hole is consistent with the center line of the adjacent connecting arm. For example, the center line of the first pass-through hole 111 is consistent with the center line of the first connecting arm 112, thereby increasing the restoring force of the circuit board 10.

The first pass-through hole 111 and the second pass-through hole 121 can prevent interference with the piezoelectric vibrators during the telescoping motion of the piezoelectric vibrators. The above situation also applies to the third main body 13.

In one embodiment of the present application, the circuit board 10 further comprises an adapter portion 16, the adapter portion 16 is installed on the upper surface of the second frame 32. The circuit board 10 also comprises a set of notches 162. The adapter portion 16 further comprises a plurality of welding holes 161, and the welding holes 161 of the adapter portion are symmetrically arranged relative to the center line of the second main body 12. The welding holes 161 of the adapter portion are distributed on both sides of at least one notch 162, thereby reducing the size of the circuit board and the size of the piezoelectric motor. The plurality of welding holes 161 of the adapter portion is located on a single side of the adapter portion 16. The welding holes 161 are used for welding and connecting the circuit board. According to the embodiment of the present invention, after the second turning body 141 is flipped to the upper side of the second frame 32, the second turning body 141 is welded and connected to the adapter portion 16 through the welding holes 161. One side of the adapter portion 16 is electrically connected to the third main body 13, thereby enabling the internal circuits of the piezoelectric motor 1, such as the circuits of the third main body 13, to be adapted through the adapter portion 16. The adapter portion 16 is connected to the second main body 12, ultimately achieving the conduction of the entire circuit board through a single line.

Referring to FIG. 11, furthermore, the first main body 11 and the second main body 12 further comprises first connecting arms 112 and second connecting arms 122, the first connecting arms 112 and the second connecting arms 122 respectively extend inward from both ends of the first main body 11 and the second main body 12 to the first mounting portion 110 and the second mounting portion 120, forming a pair of arm-shaped structures with anti-torsion functionality. This allows the first connecting arms 112 and the second connecting arms 122 to reduce the reaction force of the circuit board 10 main body.

The first connecting arms 112 and the second connecting arms 122 are symmetrically arranged relative to the first pass-through hole 111 and the second pass-through hole 121. This arrangement enhances the flexibility of the circuit board while ensuring that the piezoelectric motor is less likely to interfere during the assembly process.

It should be understood that in one embodiment of the present application, the third elastic sheet 623 provides a pre-pressure force in the horizontal direction, and under the action of the pre-pressure force, the third balls 53 are clamped between the third frame ball groove 330 and the second frame inner ball groove 3211. Since the third ball 53 is in point contact with the surface of the third frame ball groove 330 and the surface of the second frame inner ball groove 3211, when the third piezoelectric actuator 43 drives the third frame 33 to move relative to the second frame 32 along the optical axis direction, the third frame 33 may tilt, causing the third ball 53 to jam with the third frame ball groove 330, preventing the third frame 33 from continuing to move to achieve optical focusing.

Furthermore, in a specific implementation, the number of the third balls 53 is six, in such three of the third balls form a first group and are arranged at a corner of the third frame 33, and the other three third balls 53 form a second group and are arranged at the opposite corner of the third frame 33. From a top view, the two groups of third balls 53 and the third piezoelectric actuator 43 form a three-point support on the side of the third frame 33. The distance from the third piezoelectric friction head 431 of the third piezoelectric actuator 43 to the connection line of the two groups of third balls 53 is large, resulting in a large overturning moment at the diagonal of the third frame 33. This causes the third frame ball groove 330 to produce a large tilt angle when the third frame 33 is driven to move along the optical axis direction, leading to jamming between the third balls 53 and the third frame ball groove 330, and preventing the third frame 33 from continuing to move to achieve optical focusing.

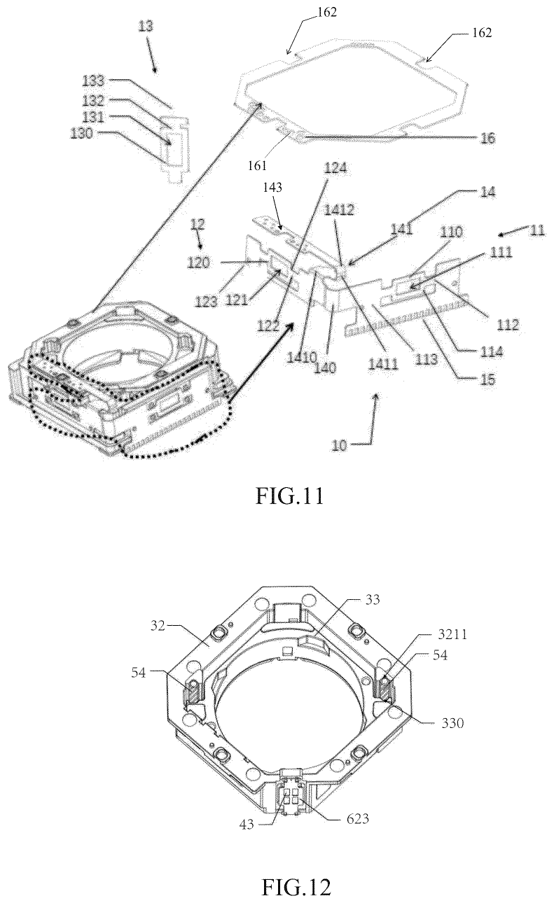

In order to avoid the above situation, in another embodiment of the present application, as shown in FIG. 12, the piezoelectric motor 1 further comprises a support guide rod 54. The support guide rod 54 extends along the optical axis direction and is clamped between the third frame ball groove 330 and the second frame inner ball groove 3211. When the third piezoelectric actuator 43 drives the third frame 33 to move relative to the second frame 32 along the optical axis direction, the support guide rod 54 always maintains support for the third frame 33.

Since the support guide rod 54 is in line contact with the surface of the third frame ball groove 330 and the surface of the second frame inner ball groove 3211, when the third piezoelectric actuator 43 drives the third frame 33 to move relative to the second frame 32 along the optical axis direction, the third frame ball groove 330 will not produce a tilt angle under the support of the support guide rod 54, thereby preventing the third frame 33 from tilting and ensuring that the optical focusing function is not affected. Specifically, the number of the support guide rods 54 is two, and the two support guide rods 54 are placed at the opposite corners of the third frame 33 respectively. From a top view, the two support guide rods 54 and the third piezoelectric actuator 43 form a three-point support on the side of the third frame 33.

In other words, in this embodiment, the third balls 53 are replaced by the support guide rods 54. Through the supporting and guiding function of the support guide rods 54, the tilting problem of the third frame 33 during movement is avoided.

Furthermore, as mentioned earlier, when the distance from the third piezoelectric friction head 431 of the third piezoelectric actuator 43 to the connection line of the two groups of third balls 53 is large, the overturning moment at the diagonal of the third frame 33 is large, causing the third frame ball groove 330 to easily produce a large tilt angle and leading to jamming between the third balls 53 and the third frame ball groove 330. In another embodiment of the present application, the above problem is avoided by reducing the moment.

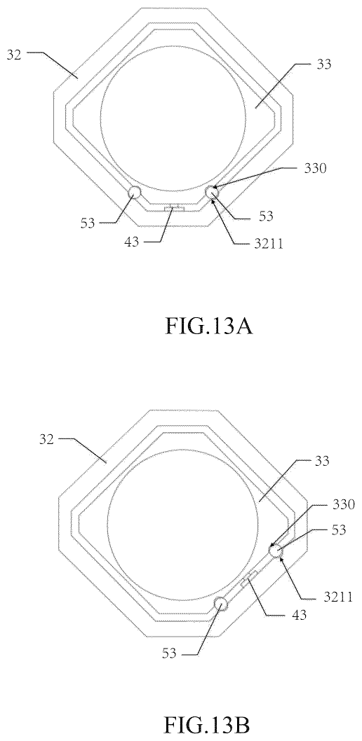

Specifically, as shown in FIG. 13A, the two groups of third balls 53 are respectively arranged adjacent to the third piezoelectric actuator 43. When the third piezoelectric actuator 43 is arranged at one corner of the third frame 33, the two groups of third balls 53 are located on the two adjacent sides relative to the third piezoelectric actuator 43. This arrangement reduces the distance from the third piezoelectric friction head 431 of the third piezoelectric actuator 43 to the connection line of the two groups of third balls 53, thereby reducing the moment when the third frame 33 is driven and avoiding the tilting of the third frame 33, which could cause jamming between the third balls 53 and the third frame 33.

Furthermore, referring to FIG. 13B, the third piezoelectric actuator 43 and the two groups of third balls 53 are arranged on the same side of the third frame 33. For example, when the third piezoelectric actuator 43 is arranged on one side of the third frame 33, the two groups of third balls 53 are located on the same side as the third piezoelectric actuator 43 and adjacent to the third piezoelectric actuator 43. This arrangement minimizes the distance from the third piezoelectric friction head 431 of the third piezoelectric actuator 43 to the connection line of the two groups of third balls 53, further reducing the moment when the third frame 33 is driven and avoiding the tilting of the third frame 33, which could cause jamming between the third balls 53 and the third frame 33.

In this embodiment, the third balls 53 can also be implemented as support guide rods 54, which is not limited in this application.

Those skilled in the art should understand that the embodiments of the present invention described above and illustrated in the drawings are merely examples and do not limit the present invention. All equivalent implementations, modifications, and improvements within the spirit of the present invention shall be included within the scope of protection of the present invention.

1-43. (canceled)

44. A piezoelectric motor, comprising:
a fixing assembly;
a movable assembly connected movably to the fixing assembly;
a piezoelectric actuator abutting against the movable assembly, wherein the movable assembly is supported on the fixing assembly by a plurality of balls arranged on one side of the movable assembly, wherein the plurality of balls form at least one support plane and a driving end of the piezoelectric actuator acts on the support plane.

45. The piezoelectric motor, as recited in claim 44, wherein the plurality of balls include a plurality of side wall balls and a plurality of end face balls, the driving end of the piezoelectric actuator has a driving direction perpendicular to a support plane formed by the plurality of side wall balls and the driving direction of the driving end of the piezoelectric actuator is parallel to a support plane formed by the plurality of end face balls.

46. The piezoelectric motor, as recited in claim 45, wherein the plurality of side wall balls include at least one first-height ball and at least one second-height ball, in a side projection, a position where the driving end of the piezoelectric actuator abuts against the movable assembly is located in at a middle area of a connection line between the at least one first-height ball and the at least one second-height ball.

47. The piezoelectric motor, as recited in claim 45, wherein the plurality of side wall balls include a first-height ball and two second-height balls, wherein in a projection, the driving end of the piezoelectric actuator has an entire stroke trajectory located within a triangular area formed by a plurality of connection lines between the first-height ball and the two second-height balls.

48. The piezoelectric motor, as recited in claim 45, wherein during at least one part of a stroke of the driving end of the piezoelectric actuator, the driving end of the piezoelectric actuator applies a force to the movable assembly that is tilted relative to the support plane formed by the plurality of side wall balls.

49. The piezoelectric motor, as recited in claim 45, wherein the plurality of side wall balls include at least one first-height ball and at least one second-height ball, wherein the at least one first-height ball and the at least one second-height ball form an equilateral triangular support plane.

50. The piezoelectric motor, as recited in claim 44, wherein the piezoelectric actuator includes a first piezoelectric actuator and a second piezoelectric actuator, the movable assembly includes a first frame and a second frame movably connected to the first frame, wherein the first piezoelectric actuator is fixedly disposed on one side of the base and the second piezoelectric actuator is fixedly disposed on one side of the first frame, the first piezoelectric actuator has a driving direction orthogonal with that of the second piezoelectric actuator.

51. A piezoelectric motor, comprising:
a fixing assembly;
a movable assembly connected movably to the fixing assembly;
a piezoelectric actuator abutting against the movable assembly, wherein the piezoelectric actuator comprises a piezoelectric vibrator and a piezoelectric friction head disposed on a side of the piezoelectric vibrator close to the movable assembly;
an elastic support portion for generating a potential energy perpendicular to a driving direction of the piezoelectric actuator and a potential energy along a height direction of the movable assembly; and
a circuit board connected to a side of the piezoelectric vibrator opposite to the piezoelectric friction head and the elastic support portion is partially arranged on a side of the circuit board away from the piezoelectric vibrator.

51. The piezoelectric motor, as recited in claim 51, further comprising a friction plate fixedly connected to one side of the movable assembly and arranged parallel to one side of the piezoelectric vibrator and the piezoelectric friction head is located at a center of the friction plate.

52. The piezoelectric motor, as recited in claim 51, wherein the elastic support portion comprising an elastic sheet for generating a potential energy perpendicular to a driving direction of the piezoelectric actuator, wherein the circuit board has a pass-through hole corresponding to a pass-through hole of the elastic sheet and the movable assembly has a pass-through hole for accommodating the piezoelectric vibrator therein.

53. The piezoelectric motor, as recited in claim 52, wherein the elastic sheet has a first through-hole having a size smaller than that of one side of the piezoelectric vibrator.

54. The piezoelectric motor, as recited in claim 53, wherein the first through-hole of the elastic sheet has a size smaller than that of the pass-through hole of the circuit board.

55. The piezoelectric motor, as recited in claim 54, wherein the elastic sheet further has a second through-hole and a third through-hole, the first through-hole has a size larger than that of the second through-hole and the third through-hole.

56. The piezoelectric motor, as recited in claim 55, wherein the areas of the elastic sheet second through-hole and the elastic sheet third through-hole are the same, and the area of the first through-hole has an area exceeds twice that of the second through-hole.

57. The piezoelectric motor, as recited in claim 56, wherein the elastic sheet further comprises a plurality of elastic sheet connecting arms for providing pressure on at least two sides of the piezoelectric vibrator.

58. The piezoelectric motor, as recited in claim 57, wherein the elastic sheet further has at least one elastic sheet positioning hole, and the elastic sheet is pressed on the movable assembly through the elastic sheet positioning hole.

59. The piezoelectric motor, as recited in claim 58, wherein the circuit board further has at least one mounting portion and the circuit board is located on the movable assembly through the mounting portion, wherein the circuit board is located on an inner side of the elastic sheet.

60. A piezoelectric motor, comprising:
a base;
a movable assembly movably connected above the base;
a piezoelectric actuator assembly abutting against the movable assembly;
a housing connected fixedly to the base and having an accommodating space, wherein the movable assembly is located within the housing;
a plurality of balls arranged between the housing and the movable assembly and between the base and the movable assembly, respectively; and
an elastic support portion for generating a potential energy applied to the plurality of ball, so as to urge the plurality of balls toward the base and clamp the plurality of balls between the housing and the movable assembly.

61. The piezoelectric motor, as recited in claim 60, further comprising a circuit board, the piezoelectric actuator assembly is fixedly connected to the circuit board, and the elastic support portion is arranged on a side of the circuit board away from the piezoelectric actuator, wherein the elastic support portion further generates potential energy perpendicular to a movement direction of the piezoelectric actuator, wherein the potential energy provided by the elastic support portion to the circuit board is perpendicular to the potential energy provided by the elastic support portion to the plurality of ball located between the housing and the movable assembly.

62. The piezoelectric motor, as recited in claim 61, wherein the movable assembly comprises a first frame and a second frame, wherein the first frame and the second frame are movably connected with each other, the first frame and the base are movably connected with each other and the second frame is movably connected within the housing through the plurality of balls, wherein the second frame has a degree of freedom of movement relative to the housing, which is in line with a degree of freedom of movement of the second frame relative to the base.

63. The piezoelectric motor, as recited in claim 62, wherein the piezoelectric actuator includes a first piezoelectric actuator and a second piezoelectric actuator, and a plane wherein the first piezoelectric actuator is located and a plane wherein the second piezoelectric actuator is located are orthogonal to each other.
